(19) United States
(12) Patent Application Publication
(10) Pub. No.: US 2023/0261840 A1
(43) Pub. Date: Aug. 17, 2023

(54) RADIO NODES, NETWORK NODES, CIRCUITRY, SYSTEMS AND METHODS

(71) Applicant: Sony Group Corporation, Tokyo (JP)

(72) Inventors: Shin Horng WONG, Basingstoke (GB); Naoki KUSASHIMA, Tokyo (JP)

(73) Assignee: Sony Group Corporation, Tokyo (JP)

(21) Appl. No.: 18/014,483

(22) PCT Filed: Jul. 22, 2021
(86) PCT No.: PCT/EP2021/070603

§ 371 Date: Jan. 5, 2023

(30) Foreign Application Priority Data
Jul. 24, 2020 (EP) 20187799.0

(51) Int. Cl. H04L 5/00; H04L 1/1812

(52) U.S. Cl. CPC H04L 5/0053; H04L 1/1812

(57) ABSTRACT

A method for acknowledging transmissions in a telecommunications network comprising a network node arranged to communicate with a mobile device via a wireless interface. The method comprises the radio node: receiving a first transmission associated with a first acknowledgement scheme; determining that the radio node is unable to transmit a first acknowledgement message for the first transmission; receiving a second transmission from the network node, the second transmission being associated with a second acknowledgement scheme, wherein the second acknowledgement scheme is different from the first acknowledgement scheme; determining acknowledgement resources associated with the second transmission and for the transmission of a second acknowledgement message for the second transmission; deciding, based on the first and second acknowledgement schemes, whether to multiplex the first and second acknowledgement messages; and if it is decided to multiplex the first and second acknowledgement messages, transmitting the first and second acknowledgement messages using the acknowledgement resources.

### FIELD

The present disclosure relates to radio nodes (also referred to as “mobile nodes”, “terminal, “UE”, “WRTU”, “communications devices”, etc.), network nodes, circuitry, systems and methods. Examples of the present disclosure can be particularly useful for transmitting and/or receiving acknowledgements in a mobile telecommunications network.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example it is expected future wireless communications networks will be expected to efficiently support communications with devices including reduced complexity devices, machine type communication devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

Example use cases currently considered to be of interest for next and latest generation wireless communication systems include so-called Ultra Reliable and Low Latency Communications (URLLC)/enhanced Ultra Reliable and Low Latency Communications (eURLLC). See, for example, the 3GPP documents RP-160671, “New SID Proposal: Study on New Radio Access Technology,” NTT DOCOMO, RAN #71 [1]; RP-172834, “Work Item on New Radio (NR) Access Technology,” NTT DOCOMO, RAN #78 [2]; RP-182089, “New SID on Physical Layer Enhancements for NR Ultra-Reliable and Low Latency Communication (URLLC),” Huawei, HiSilicon, Nokia, Nokia Shanghai Bell, RAN #81 [3]; and RP-190654, “Physical layer enhancements for NR ultra-reliable and low latency communication (URLLC),” Huawei, HiSilicon, RAN #89, Shenzhen, China, 18 to 21 Mar. 2019 [4].

URLLC services are low latency and high reliability services (e.g. to support applications such as factory automation, transport industry, electrical power distribution etc.). URLLC services might, for example, aim to transmit data through a radio network with a target 32-byte packet transit time (i.e. time from ingress of a layer 2 packet to its egress from the network) of 1 ms (i.e. so that each packet needs to be scheduled and transmitted across the physical layer in a time that is shorter than 1 ms) with 99.999% reliability within the 1 ms target packet transit time [5], and there are recent proposals for this to be increased to 99.9999% with a latency between 0.5 ms and 1 ms.

The 3GPP project has recently completed a Release-16 Work Item on eURLLC [6] to specify features that require high reliability and low latency such as factory automation, transport industry, electrical power distribution, etc. in a 5G system. The eURLLC feature is further enhanced in Release-17 in a new Work Item [7], where one of the objectives is to enhance acknowledgment signalling (HARQ-ACK feedback) in respect of URLLC downlink transmissions.

### SUMMARY

The invention is defined in the independent claims. Further example embodiments are provided in the dependent claims.

According to an aspect of the present disclosure, there is provided a method for acknowledging transmissions in a telecommunications network, the telecommunications network comprising a network node arranged to communicate with a mobile device via a wireless interface. The method comprises the radio node: receiving a first transmission from the network node, the first transmission being associated with a first acknowledgement scheme; determining that the radio node is unable to transmit a first acknowledgement message for the first transmission; receiving a second transmission from the network node, the second transmission being associated with a second acknowledgement scheme, wherein the second acknowledgement scheme is different from the first acknowledgement scheme; determining acknowledgement resources associated with the second transmission and for the transmission of a second acknowledgement message for the second transmission; deciding, based on the first and second acknowledgement schemes, whether to multiplex the first and second acknowledgement messages; and if it is decided to multiplex the first and second acknowledgement messages, transmitting the first and second acknowledgement messages using the acknowledgement resources.

It will be appreciated that, in the present disclosure, the radio node may also be referred to as a communications device, user device, terminal, etc.

According to another aspect of the present disclosure, there is provided a radio node for acknowledging transmissions in a telecommunications network, the telecommunications network comprising a network node arranged to communicate with the mobile device via a wireless interface. The radio node is configured to receive a first transmission from the network node, the first transmission being associated with a first acknowledgement scheme; determine that the radio node is unable to transmit a first acknowledgement message for the first transmission; receive a second transmission from the network node, the second transmission being associated with a second acknowledgement scheme, wherein the second acknowledgement scheme is different from the first acknowledgement scheme; determine acknowledgement resources associated with the second transmission and for the transmission of a second acknowledgement message for the second transmission; decide, based on the first and second acknowledgement schemes, whether to multiplex the first and second acknowledgement messages; and transmit, if it is decided to multiplex the first and second acknowledgement messages, the first and second acknowledgement messages using the acknowledgement resources.

According to a further aspect of the present disclosure, there is provided circuitry for a radio node in a telecommunications network, the telecommunications network the telecommunications network comprising a network node arranged to communicate with a mobile device via a wireless interface. The circuitry comprises a controller element and a transceiver element configured to operate together to receive a first transmission from the network node, the first transmission being associated with a first acknowledgement scheme; determine that the radio node is unable to transmit a first acknowledgement message for the first transmission; receive a second transmission from the network node, the second transmission being associated with a second acknowledgement scheme, wherein the second acknowledgement scheme is different from the first acknowledgement scheme; determine acknowledgement resources associated with the second transmission and for the transmission of a second acknowledgement message for the second transmission; decide, based on the first and second acknowledgement schemes, whether to multiplex the first and second acknowledgement messages; and transmit, if it is decided to multiplex the first and second acknowledgement messages, the first and second acknowledgement messages using the acknowledgement resources.

According to an aspect of the present disclosure, there is provided a method for receiving transmissions acknowledgements in a telecommunications network, the telecommunications network comprising a network node arranged to communicate with a mobile device via a wireless interface, the method comprising the network node: transmitting a first transmission to the radio node, the first transmission being associated with a first acknowledgement scheme; determining that the radio node is unable to transmit a first acknowledgement message for the first transmission; transmitting a second transmission to the radio node, the second transmission being associated with a second acknowledgement scheme, wherein the second acknowledgement scheme is different from the first acknowledgement scheme; determining acknowledgement resources associated with the second transmission and for the transmission of a second acknowledgement message for the second transmission; deciding, based on the first and second acknowledgement schemes, whether to expect the first and second acknowledgement messages to be multiplexed; and if the first and second acknowledgement messages are expected to be multiplexed, obtaining the first acknowledgement message and second acknowledgement message from the acknowledgement resources.

According to another aspect of the present disclosure, there is provided a network node for receiving transmissions acknowledgements in a telecommunications network, the network node being configured to communicate with a mobile device via a wireless interface. The network node is further configured to: transmit a first transmission to the radio node, the first transmission being associated with a first acknowledgement scheme; determine that the radio node is unable to transmit a first acknowledgement message for the first transmission; transmit a second transmission to the radio node, the second transmission being associated with a second acknowledgement scheme, wherein the second acknowledgement scheme is different from the first acknowledgement scheme; determine acknowledgement resources associated with the second transmission and for the transmission of a second acknowledgement message for the second transmission; decide, based on the first and second acknowledgement schemes, whether to expect the first and second acknowledgement messages to be multiplexed; and if the first and second acknowledgement messages are expected to be multiplexed, obtain the first acknowledgement message and second acknowledgement message from the acknowledgement resources.

According to a further aspect of the present disclosure, there is provided circuitry for a network node in a telecommunications network, wherein the circuitry comprises a controller element and a transceiver element configured to operate together to communicate with a mobile device via a wireless interface, and wherein the controller element and the transceiver element are further configured to operate together to transmit a first transmission to the radio node, the first transmission being associated with a first acknowledgement scheme; determine that the radio node is unable to transmit a first acknowledgement message for the first transmission; transmit a second transmission to the radio node, the second transmission being associated with a second acknowledgement scheme, wherein the second acknowledgement scheme is different from the first acknowledgement scheme; determine acknowledgement resources associated with the second transmission and for the transmission of a second acknowledgement message for the second transmission; decide, based on the first and second acknowledgement schemes, whether to expect the first and second acknowledgement messages to be multiplexed; and if the first and second acknowledgement messages are expected to be multiplexed, obtain the first acknowledgement message and second acknowledgement message from the acknowledgement resources.

According to an aspect of the present disclosure, there is provided a system comprising a network node and a radio node, the network node being configured to communicate with the mobile device via a wireless interface, wherein the network node is as discussed above and wherein the radio node is as discussed above.

According to an aspect of the present disclosure, there is provided a computer program product comprising instructions which, when the program is executed by a computer, cause the computer to carry out a method as discussed above.

It is to be understood that both the foregoing general description and the following detailed description are illustrative, but are not restrictive, of the present technology. The described examples devices, systems or methods of the present disclosure, together with associated teachings, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an example LTE-type wireless telecommunication network;

FIG. 2 schematically represents some aspects of an example new radio (NR) access technology (RAT) wireless telecommunications network;

FIG. 3 schematically represents an example telecommunications system;

FIGS. 4 to 6 schematically show example uses of radio resources associated with a communications device in an uplink grid of radio communications resources (top half of figure) and downlink grid of radio communications resources (bottom half of figure);

FIG. 7 schematically represents an example of a New Radio Unlicensed (NR-U) Channel Access on a grid of radio communications resources;

FIG. 8 schematically represents Type 1 and Type 2 Dynamic Channel Access on an uplink and downlink grid of radio communications resources;

FIG. 9 schematically represents example configurations for Type 2 Dynamic Channel Access on a grid of radio communications resources;

FIG. 10 schematically represents examples of HARQ-ACK transmission failures on an uplink and downlink grid of radio communications resources;

FIG. 11 schematically represents an example use of an e-type 2 Codebook on an uplink and downlink grid of radio communications resources for channel access;

FIG. 12 schematically represents an example use of a type 3 Codebook on an uplink and downlink grid of radio communications resources for channel access;

FIG. 13 schematically represents an example use of a combination of an e-Type 2 Codebook and a Type 2 Codebook on an uplink and downlink grid of radio communications resources for channel access;

FIG. 14 schematically represents an example method for acknowledging transmissions in a telecommunications network; and

FIG. 15 schematically represents an example method for receiving transmissions acknowledgements.

In the following description, reference is made to the accompanying drawings which illustrate several examples of the present disclosure. It is to be understood that other examples may be implemented and system or method changes may be made without departing from the teachings of the present disclosure. The following detailed description is not to be taken in a limiting sense, and the scope of the embodiments of the present invention is defined only by the claims. It is to be understood that drawings are not necessarily drawn to scale. Some examples of the present disclosure may not fall within the scope of the claims but are useful for understanding the technical field of the invention and the teachings of the present disclosure.

### DESCRIPTION OF EXAMPLES

### Long Term Evolution Advanced Radio Access Technology (4G)

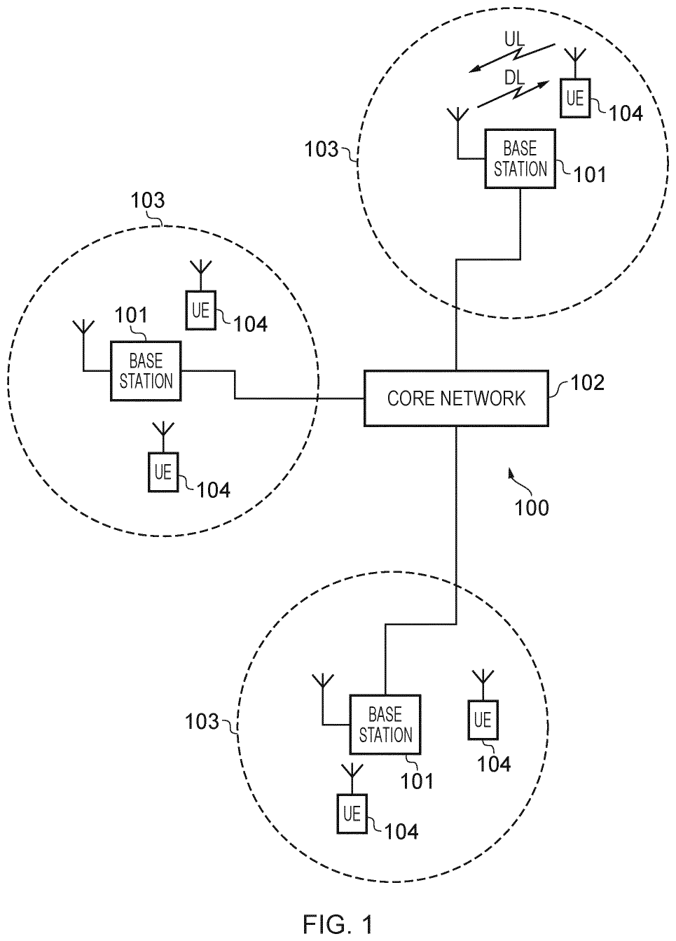

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [9]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

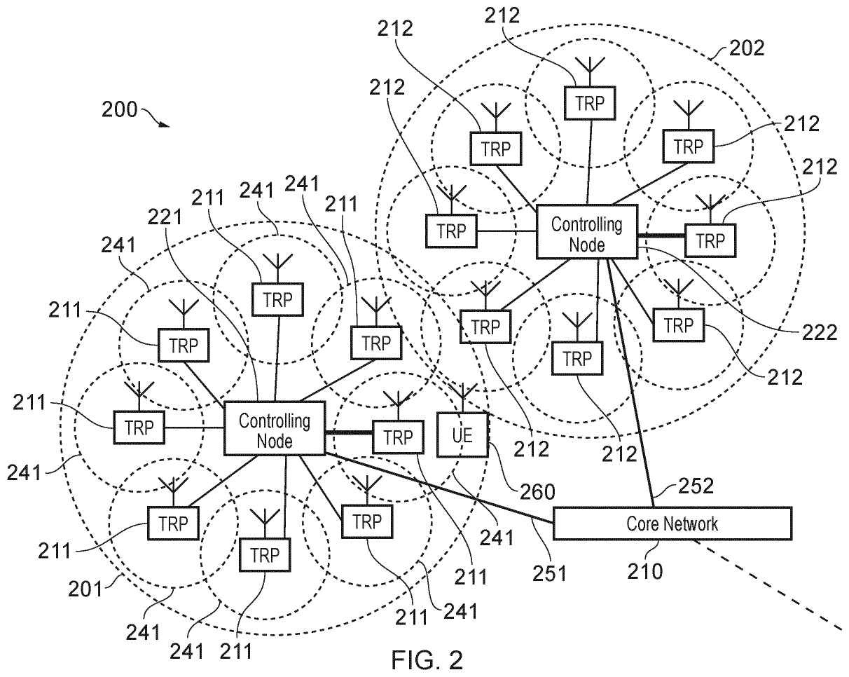

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

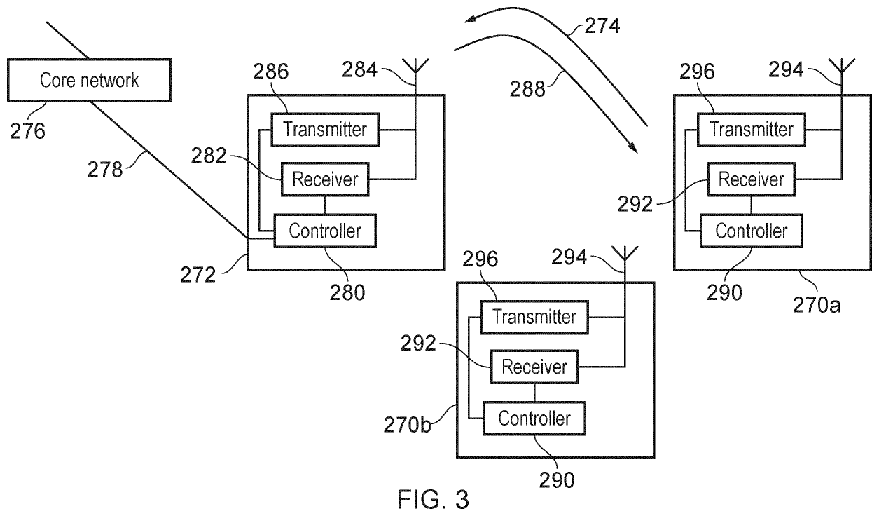

A more detailed illustration of a UE 270 and an example network infrastructure equipment 272, which may be thought of as a gNB 101 or a combination of a controlling node 221 and TRP 211, is presented in FIG. 3. As shown in FIG. 3, the UE 270 is shown to receive downlink data from the infrastructure equipment 272 via resources of a wireless access interface as illustrated generally by an arrow 274. The UE 270 receives the downlink data transmitted by the infrastructure equipment 272 via communications resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Example Services

As mentioned above, there are a variety of services which may be supported by wireless communications networks. Development of physical layer, radio access and media access protocols and techniques can be adapted to support such services. Example services which are being defined for 5G/New Radio (NR) are the Ultra-Reliable and Low Latency Communications (URLLC) and the enhanced Mobile BroadBand (eMBB) services. URLLC has very low latency and high reliability where a URLLC data packet (e.g. 32 bytes) is required to be transmitted from the radio protocol layer ingress point to the radio protocol layer egress point of the radio interface within 1 ms with a reliability of 99.999% [5] to 99.9999%. On the other hand, eMBB requires high data rate of for example 20 Gbps with moderate latency and reliability (e.g. 99% to 99.9%).

Example developments for 3GPP are eURLLC [6] and NR Unlicensed (NR-U) [8]. For the example of eURLLC proposals have been made to specify features for high reliability and low latency services such as factory automation, transport industry, electrical power distribution, etc. in a 5G system. Unlicensed radio frequency resources refers to a concept in which the radio resources are not exclusively allocated to a particular operator or radio communications system but are shared between systems, which to some extent compete for these resources. An example application for unlicensed spectrum is a 3GPP Release-16 NR-U work item which specifies features which include incorporating Listen Before Talk (LBT) in NR frame structure to enable NR operation in unlicensed bands.

Further developments of eURLLC have been proposed for 3GPP Release-17 in a work item [7] where one of the objectives is to incorporate characteristics associated with communicating via unlicensed radio resources, which thereby enable eURLLC operation in an unlicensed band.

One aspect which should be addressed for use of eURLLC in an unlicensed frequency resource is HARQ-ACK feedback for PDSCH.

### PDSCH HARQ-ACK Feedbacks

Certain embodiments of the disclosure relate to apparatus and methods for handling acknowledgment signalling (e.g. HARQ-ACK signalling) in respect of transmissions of data in a wireless telecommunications system. Acknowledgment signalling is used in wireless telecommunications systems to indicate whether a transmission was successfully received or not. If the transmission was successfully received the receiving entity will send positive acknowledgment signalling (i.e. an ACK), and if the transmission was not successfully received the intended recipient entity will send negative acknowledgment signalling (i.e. a NACK). The term acknowledgment signalling will be used herein to refer collectively to both positive acknowledgment signalling (i.e. ACK) and negative acknowledgment signalling (i.e. NACK).

For scheduled transmission of data from a network access node (base station) to a communications device in a wireless telecommunications system it is common for the network access node to first send control signalling, e.g. on a downlink control channel (such as a PDCCH—Physical Downlink Control Channel), comprising downlink control information (DCI) which indicates (grants) downlink radio resources that are to be used to transmit the data, e.g. on a downlink shared channel (such as a PDSCH). From this the communications device can determine uplink radio resources to use to send uplink control information (UCI) comprising acknowledgment signalling in respect of the data, e.g. on an uplink control channel (such as a PUCCH), although it may also be on an uplink shared channel (such as a PUSCH). The communications device then seeks to receive the data on the indicated radio resources on the downlink shared channel. If the communications device successfully decodes the data it transmits a UCI on the determined uplink radio resources comprising an ACK indication, and if the communications device does not successfully decode the data it transmits a UCI on the determined uplink radio resources comprising a NACK indication. This allows the network access node to determine if it should schedule a retransmission of the data.

So as to provide some particular examples, certain embodiments of the disclosure will be described herein in the context of acknowledgement signalling for downlink transmissions of URLLC data and using terminology, for example in respect of channel names such as PUCCH and PDSCH and signalling names, such as DCI and UCI, which are typically used in connection with current 3GPP wireless telecommunications systems. However, it will be appreciated this is only for convenience, and in general the approaches discussed herein are applicable for other service types and in wireless telecommunications systems which use different terminology. Thus, references herein to PUCCH should, unless the context demands otherwise, be read as referring to a physical uplink control channel generally, and not specifically to a particular format of physical uplink control channel, and so on for other channels and terminology that may be referred to herein.

HARQ-ACK (Hybrid Automatic Repeat Request acknowledgement signalling) feedback is transmitted by a communications device to a base station in respect of PDSCH scheduling to inform the base station whether the communications device has successfully decoded the corresponding PDSCH or not. Radio resources in wireless telecommunications resources comprise a grid of resources (i.e. a radio frame structure) spanning frequency and time. The frequency dimension is divided into sub-carriers and the time dimension is divided into symbols that are grouped into slots.

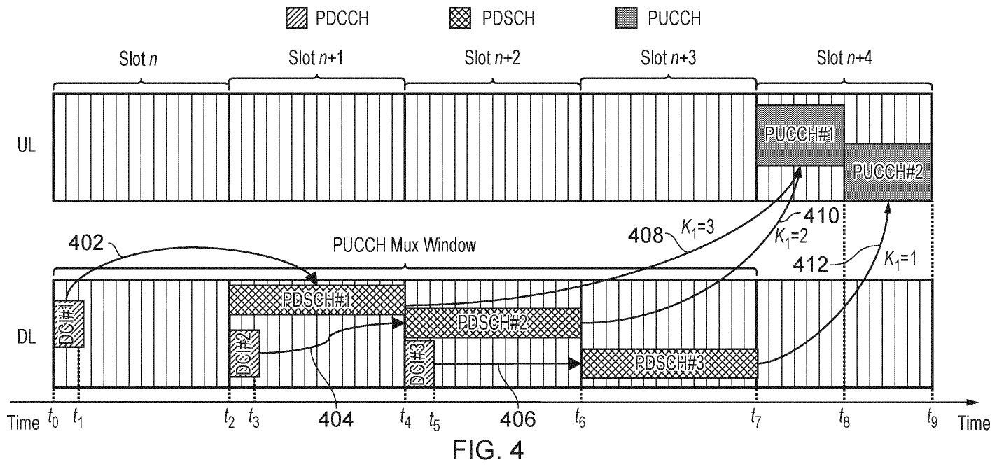

In some current systems, for a PDSCH ending in slot n, the corresponding PUCCH carrying the HARQ-ACK acknowledgement signalling is transmitted in slot n+K₁, where the value of K₁ is indicated in the field “PDSCH-to-HARQ_feedback timing indicator” in the downlink (DL) Grant for the PDSCH (carried by DCI (downlink control information) Format 1_0 or DCI Format 1_1). Multiple (different) PDSCHs can point to the same slot for transmission of their respective HARQ-ACKs, and multiple HARQ-ACKs in the same slot can be multiplexed into a single PUCCH. Hence a PUCCH can contain multiple HARQ-ACKs for multiple PDSCHs. An example of this is represented FIG. 4.

FIG. 4 schematically shows an uplink radio resource grid (top half of figure) and downlink radio resource grid (bottom half of figure) representing radio resources in time (horizontal axis) and frequency (vertical axis). FIG. 4 schematically shows radio resources used by a communications device In an example, scenario during a period spanning five slots (identified in FIG. 4 as slots n to n+4). In slot n the communications device receives downlink control information (DCI #1) indicating an allocation of radio resources (represented by arrow 402) on a physical downlink shared channel (PDSCH #1) in slot n+1 with a PDSCH-to-HARQ_feedback timing indicator value of K₁=3 and a “PUCCH Resource Indicator” (PRI) field indicating resources in the first half of the slot (i.e. PUCCH #1 in FIG. 4). In slot n+1 the communications device receives downlink control information (DCI #2) indicating an allocation of radio resources (represented by arrow 404) on a physical downlink shared channel (PDSCH #2) in slot n+2 with a PDSCH-to-HARQ_feedback timing indicator value of K₁=2 and a PRI field indicating the same resources in the first half of the slot as for DCI #1 (i.e. PUCCH #1). In slot n+2 the communications device receives downlink control information (DCI #3) indicating an allocation of radio resources (represented by arrow 406) on a physical downlink shared channel (PDSCH #3) in slot n+3 with a PDSCH-to-HARQ_feedback timing indicator value of K₁=1 and a PRI field indicating resources in the second half of the slot (i.e. PUCCH #2 in FIG. 4). Thus, in this particular example scenario, the HARQ-ACK feedbacks for each of the three downlink transmissions on the physical downlink shared channel are scheduled to be transmitted by the communications device in slot n+4 (as represented by arrows 408, 410, 410) and so can be transmitted in a multiplexed manner. To support this multiplexed HARQ-ACK function a Multiplexing Window may be defined, wherein the Multiplexing Window is a time window indicating how many PDSCHs can have their associated HARQ-ACK signalling multiplexed in PUCCH in a single slot and may depend on the range of K₁ values. In the example in FIG. 4, the PUCCH Multiplexing Window is assumed to be from Slot n to Slot n+3, which means the max K₁ value that can be used in this period is 4.

For the example represented in FIG. 4 there are two PUCCH indicated for the communications device in slot n+4 (i.e. PUCCH #1 on symbols comprising the first half of the slot and PUCCH #2 on symbols comprising the second half of the slot). For wireless telecommunications systems operating in accordance with some systems (e.g. a Release 15 system), only one PUCCH per slot is allowed to carry HARQ-ACKs for the same communications device, even in the case of different indicated PUCCHs that do not overlap in time, as in FIG. 4. Thus, when a communications device operating in accordance with these systems is to multiplex HARQ-ACK signalling for multiple PDSCH, it does so using the PUCCH resources indicated in the PRI associated with the last PDSCH in the PUCCH Multiplexing Window (since the communications device will only know the total number of HARQ-ACK bits after last PDSCH is allocated). Thus, in the example in FIG. 4, DCI #1 and DCI #2 indicate PUCCH #1 for the HARQ-ACK signalling, but DCI #3 indicates PUCCH #2. Even though PUCCH #1 and PUCCH #2 do not overlap in time in this example, they cannot both be transmitted in the same slot according to these systems (e.g. a Release 15 system). In this case, since DCI #3 schedules the last PDSCH, i.e. PDSCH #3, in the PUCCH Multiplexing Window, the communications device will use PUCCH #2 to carry the multiplexed HARQ-ACK for PDSCH #1, PDSCH #2 and PDSCH #3. (It may be noted that PUCCH carrying other UCI, such as a Scheduling Request (SR) may be transmitted separately from a PUCCH carrying HARQ-ACK in the same slot if they do not overlap in time).

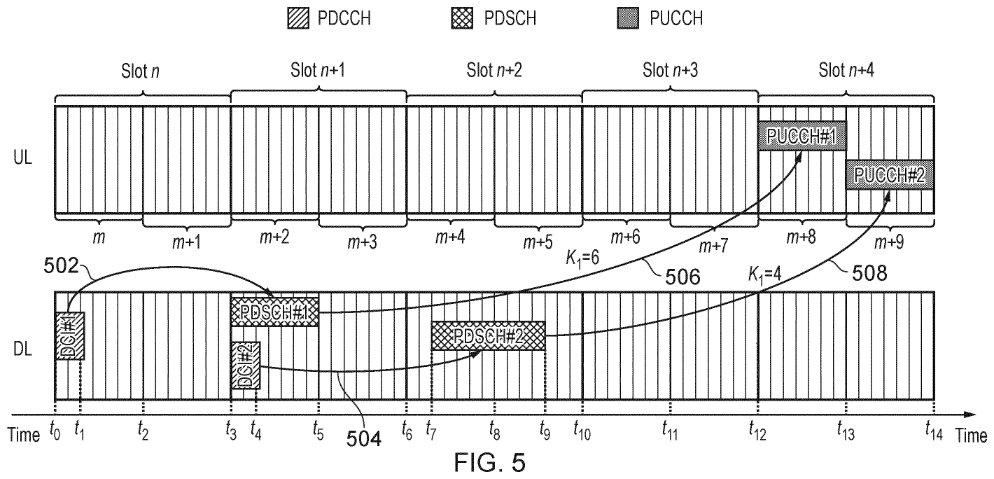

For other systems (e.g. a Release 16 system), the possibility of sub-slot operation for HARQ-ACK acknowledgement signalling was introduced. Sub-slot operation for HARQ-ACK allows the timings of HARQ-ACK UCI on PUCCH to be configured with a resolution which is less than one slot (i.e. the HARQ-ACK process operates with sub-slot timing granularity). Sub-slot based PUCCH thus allows more than one PUCCH carrying HARQ-ACKs to be transmitted within a slot. This provides for more opportunities for PUCCH carrying HARQ-ACK in respect of PDSCH transmissions to be transmitted within a slot, thereby potentially helping to reduce the latency of HARQ-ACK feedback. In a sub-slot based PUCCH, the granularity of the K₁ parameter (i.e. the time difference between the end of PDSCH and the start of its corresponding PUCCH) is in units of sub-slot instead of slot, where the sub-slot size can be 2 symbols or 7 symbols. An example of sub-slot HARQ-ACK operation is shown in FIG. 5.

FIG. 5 is similar to, and will be understood from, FIG. 4, but this example schematically shows an uplink radio resource grid (top half of figure) and downlink radio resource grid (bottom half of FIG. representing radio resources in time (horizontal axis) and frequency (vertical axis) in a scenario that support sub-slot operation for HARQ-ACK feedback with a sub-slot size of 7 symbols (i.e. half a slot in this case). Thus FIG. 5 schematically shows radio resources used by a communications device In an example, scenario during a period spanning five slots (identified in FIG. 5 as slots n to n+4)/ten sub-slots (identified in FIG. 5 as sub-slots m to m+9). In sub-slot m the communications device receives downlink control information (DCI #1) indicating an allocation of radio resources (represented by arrow 502) on a physical downlink shared channel (PDSCH #1) in sub-slot m+2 with a PDSCH-to-HARQ_feedback timing indicator value of K₁=6. This means the communications device determines the resources PUCCH #1 to use for transmitting acknowledgement signalling in respect of PDSCH #1 (represented by arrow 506) as indicated by the PRI associated with DC #1 in sub-slot m+8 (since this is the sub-slot which is K₁=6 sub-slots after the sub-slot in which PDSCH #1 ends). In sub-slot m+2 the communications device receives downlink control information (DCI #2) indicating an allocation of radio resources (represented by arrow 504) on a physical downlink shared channel (PDSCH #2) that spans sub-slots m+4 and m+5 with a PDSCH-to-HARQ_feedback timing indicator value of K₁=4. This means the communications device determines the resources PUCCH #2 to use for transmitting acknowledgement signalling in respect of PDSCH #2 (represented by arrow 506) as indicated by the PRI associated with DCI #2 in sub-slot m+9 (since this is the sub-slot which is K₁=4 sub-slots after the sub-slot in which PDSCH #2 ends). In contrast to approaches according to the systems discussed above (e.g. a Release 15 system), where only one PUCCH carrying HARQ-ACK is allowed in a slot, in a sub-slot based operation, a communications device can transmit two PUCCH carrying HARQ-ACK (i.e. PUCCH #1 and PUCCH #2) in a slot.

### Uplink L1 Priority Indicator

Certain embodiments as described in the following paragraphs may concern a different priority indicator when uplink resources are allocated to a UE for uplink transmissions. A priority indicator for uplink transmissions has been proposed for 3GPP standards, in which a different priority is allocated for uplink transmissions where these uplink transmissions collide and so one must be chosen over the other. In previous versions of 3GPP standards, such as for example the systems discussed above (e.g. a Release 15 system), there was no provision for a different priority level at the Physical Layer and when two uplink transmissions collide, information for uplink transmissions is multiplexed and transmitted using a single channel. Possible collisions of uplink resources can include a PUCCH with PUCCH and PUCCH with PUSCH. In this respect the collision occurs and can be identified at the physical layer. The systems discussed above (e.g. a Release 15 system) and other systems provided different priority levels for the media access control layer, which included sixteen priority levels, but not the physical layer.

As explained above, a UE can be configured to provide eMBB and URLLC services contemporaneously. Since eMBB and URLLC have different latency requirements, their uplink transmissions may collide. For example, after an eMBB uplink transmission has been scheduled, an urgent URLLC packet arrives which would need to be scheduled immediately and its transmission may collide with the eMBB transmission. In order to handle such intra-UE collisions with different latency and reliability requirements, two priority levels at the physical layer have been proposed in Release-16 for Uplink transmissions, such as for example transmissions via PUCCH and PUSCH channels. In Release-16 intra-UE prioritisation is used, that is, when two UL transmissions with different Physical Layer priority levels (L1 priority) collide, the UE will drop the lower priority transmission. If both UL transmissions have the same L1 priority then the UE is configured to multiplex the transmissions according to that proposed in Release-15 procedures. The gNB indicates the L1 priority to the UE in the 1 bit “Priority indicator” DCI field, where “0” indicates Low L1 priority and “1” indicates High L1 priority and:
For PUSCH, the L1 priority is indicated in the uplink grant carried by DCI Format 0_1 and 0_2
For PUCCH carrying HARQ-ACK feedback for PDSCH, the L1 priority is indicated in the Downlink grant scheduling a PDSCH, carried by DCI Format 1_1 and 1_2

According to these examples therefore, the downlink control information (DCI) carries a priority level indicator associated with the uplink transmission associated with the downlink transmission for which resources are being granted by the downlink control information, and the indicator may be different for different DCI formats depending on whether the downlink control information scheduling a PUSCH or a PUCCH.

### HARQ-ACK Codebook

HARQ-ACK codebook is used to carry multiple HARQ-ACK feedbacks for PDSCH. In some systems, such as Release-15 systems, there are two types of HARQ-ACK codebooks:
Type 1 HARQ-ACK codebook: Also known as semi-static HARQ-ACK codebook where the number of HARQ-ACK entries is fixed, i.e. semi-statically configured by RRC. Since the HARQ-ACK entries are fixed, there is no confusion between UE and gNB on the number of HARQ-ACK feedbacks the UE should transmit to the gNB if the UE missed a downlink grant (i.e. missed a PDSCH). However, allocated a fixed number of HARQ-ACK feedbacks can waste resources since PDSCH that are not scheduled are still being feedback as NACK.
Type 2 HARQ-ACK codebook: Also known as dynamic HARQ-ACK codebook where the number of HARQ-ACK entries is dynamic and based on the actual number of PDSCH being received. To avoid confusion on the number of HARQ-ACK feedbacks due to UE missing Downlink grants a “Downlink Assignment Index” (DAI) is used to keep track of the number of PDSCH transmitted to the UE. The DAI is included in the Downlink grant and is incremented when the gNB schedules a PDSCH to the UE using Type 2 HARQ-ACK codebook.

Since the PUCCH can have two L1 priorities, two HARQ-ACK codebooks of different priorities can be configured for a UE. This allows High L1 priority HARQ-ACKs to be multiplexed into a High L1 priority HARQ-ACK codebook and Low L1 priority HARQ-ACKs to be multiplexed into a Low L1 priority HARQ-ACK codebook.

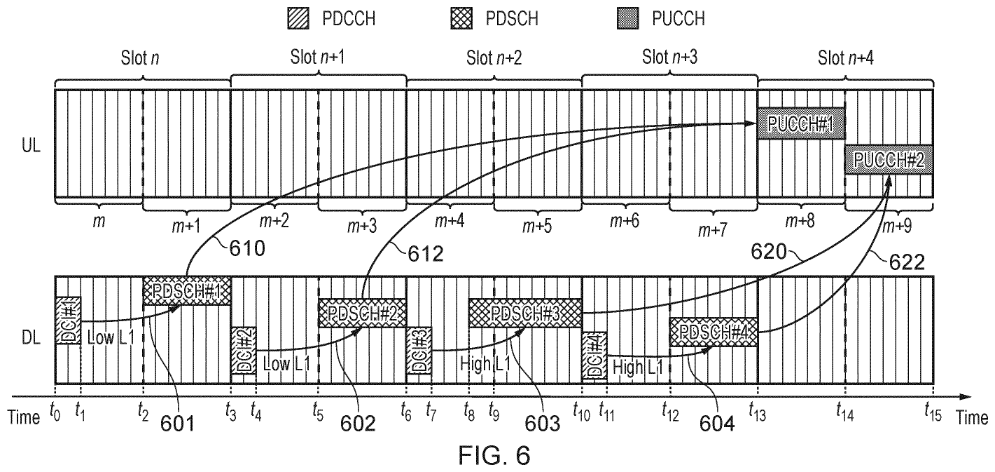

An example is shown in FIG. 6 which illustrates an arrangement in which two HARQ-ACK codebooks are provided with two different priorities. In the example shown in FIG. 6, the gNB transmits to the UE in a PDCCH (downlink control channel) a sequence of four downlink control information transmissions DCI #1, DCI #2, DCI #3, DCI #4, which respectively indicate an allocation of downlink resources PDSCH #1, PDSCH #2, PDSCH #3, PDSCH #4 respectively as represented by arrows 601, 602, 603, 604. As indicated in FIG. 6, two of the downlink control information transmissions DCI #1, DCI #2 schedule a Low L1 priority PUCCH #1 in sub-slot m+8 which carries a Low L1 priority HARQ-ACK codebook to multiplex the HARQ-ACK feedbacks for PDSCH #1 and PDSCH #2 as represented by arrows. In contrast the second two downlink control information transmissions DCI #3, DCI #4 schedule a High L1 priority PUCCH #2 in sub-slot m+9 which carries a High L1 priority HARQ-ACK codebook to multiplex the HARQ-ACK feedbacks for PDSCH #3, PDSCH #4 as represented by arrows 620, 622. Hence, according to this example, the gNB can use different PUCCH that can have different reliability to carry HARQ-ACK with different L1 priorities.

### Channel Access in an Unlicensed Band

In the following paragraphs, an explanation is provided of current proposals for accessing communications from an unlicensed frequency band. In an unlicensed band, two or more systems may operate to communicate using the same communications resources. As a result, transmissions from different systems can interfere with each other especially when for example, each of the different systems are configured according to different technical standards, for example WiFi and 5G. As such, there is a regulatory requirement to use a Listen Before Talk (LBT) protocol for each transmitter operating in an unlicensed band to reduce interferences among different systems sharing that band. In LBT, a device that wishes to transmit a packet will firstly sense the band for any energy levels above a threshold to determine if any other device is transmitting, i.e. “listen”, and if there is no detected transmission, the device will then transmit its packet. Otherwise, if the device senses a transmission from another device it will back-off and try again at a later time.

In NR-U the channel access can be Dynamic (also known as Load Based Equipment) or Semi-Static (also known as Frame Based Equipment), where in both channel access schemes consist of one or more Clear Channel Assessment (CCA) process in a Contention Window followed by a Channel Occupancy Time (COT) as shown FIG. 7. LBT is performed during the CCA phase by an NR-U device (e.g. gNB or UE) that wishes to perform a transmission. According to the CCA phase the NR-U device listens to one or more of the CCA attempts and if no other transmission is detected (i.e. energy level below a threshold) after the CCA phase, the NR-U device moves into the COT phase where it can transmit its packet in the COT resources. In Dynamic Channel Access (DCA) the CCA and COT phases can be different length between different systems whilst in Semi-static Channel Access, the CCA and COT phases have fixed time window and are synchronized for all systems sharing the band.

In NR-U a device can be an initiating device or a responding device. The initiating Device acquires the COT by performing CCA and typically it initiates a first transmission, e.g. a gNB transmitting an uplink grant. The responding device receives the transmission from the initiating device and responses with a transmission to the initiating device, e.g. a UE receiving an uplink grant and transmits the corresponding PUSCH. As will be appreciated a UE can also be an initiating device, for example when it is transmitting a Configured Grant PUSCH and the gNB can be a responding device.

There are two types of Dynamic Channel Access (DCA), which are referred to as Type 1 and Type 2. In a Type 1 DCA, Counter N is generated as a random number between 0 and CWₚ, where Contention Window size CWₚ is set between CW_{min,p} and CW_{max,p}. The duration of the COT and the values {CW_{min,p}, CW_{max,p}} depend on the value p, which is the Channel Access Priority Class (CAPC) of the transmission, which may be determined for example by a QoS of the transmitting packet. A Type 1 DCA is performed by an initiating device and once the COT is acquired one or more responding devices can use Type 2 DCA for their transmissions within the COT. Type 2 DCA may require a short CCA or no CCA prior to transmission if the gap between one transmission of two devices is less than 25 μs. If the gap is greater than 25 μs then the responding device needs to perform Type 1 DCA.

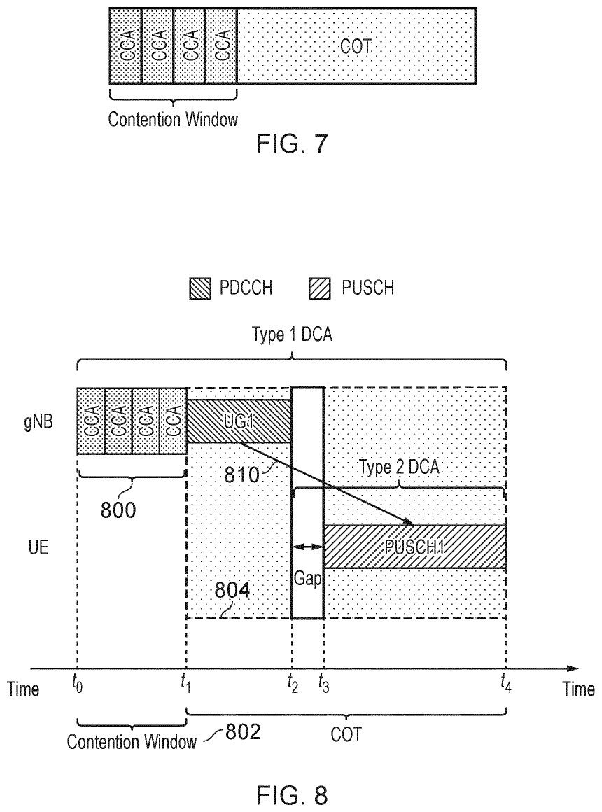

FIG. 8 provides an illustration of frequency against time for transmission in an unlicensed band. As shown for the example of FIG. 8, an example of Type 1 DCA transmission and a Type 2 DCA is shown. According to the example shown in FIG. 8, at time t₀, the gNB wishes to send an uplink grant, UG1, to the UE to schedule PUSCH1. The gNB performs a Type 1 DCA starting with a Contention Window with four CCA's 800, so that for this example random number N=4, and detects no energy during this Contention Window 802 thereby acquiring the COT 804 between time t₁ to t₄. The gNB then transmits UG1 to the UE scheduling a PUSCH1 at time t₃ as represented by arrow 810. The UE receiving the uplink grant UG1 then can use Type 2 DCA if the gap between UG1 and the start of its PUSCH1 transmission, between time t₂ and t₃ is below a threshold, otherwise the UE will have to perform a Type 1 DCA. This is to say, if the granted PUSCH1 is less than a threshold time from the gNB's transmission of the uplink grant UG1, then the UE is not required to make a contention itself for the resources on the unlicensed band by transmitting in the CCA and then COT according to the Type 1 DCA.

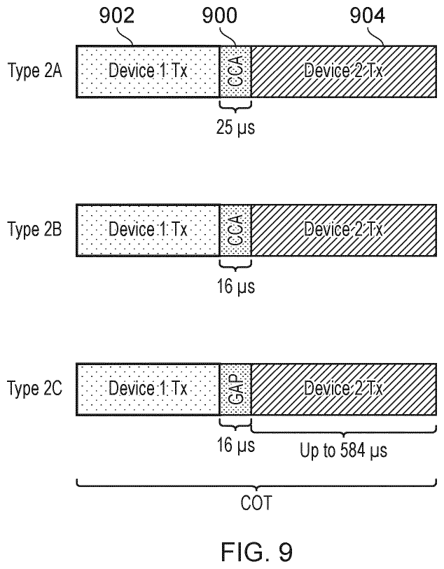

There are three types of Type 2 DCA as shown in FIG. 9, which are defined with respect to a length of the gap 900 between transmission 902 by a first device (initiating device) and a second device 904 (responding device) within a COT and therefore whether the second responding device needs to perform a CCA:
Type 2A: The gap between two transmissions is not more than 25 μs and the UE performs a single contentious channel access (CCA) within this gap 900
Type 2B: The gap between two transmissions is not more than 16 μs and the UE performs a single CCA within this gap 900
Type 2C: The gap between two transmissions is not more than 16 μs no CCA is required within this gap 900

### Enhanced HARQ-ACK

In a licensed band, the gNB can schedule the PUCCH resources precisely at a specific slot/sub-slot and other users are not expected to use the schedule resources. However, in an unlicensed band operation, due to the need for LBT (or CCA), the scheduled resources for PUCCH may not be available if the UE fails the LBT process, for example due to traffic using the unlicensed resources.

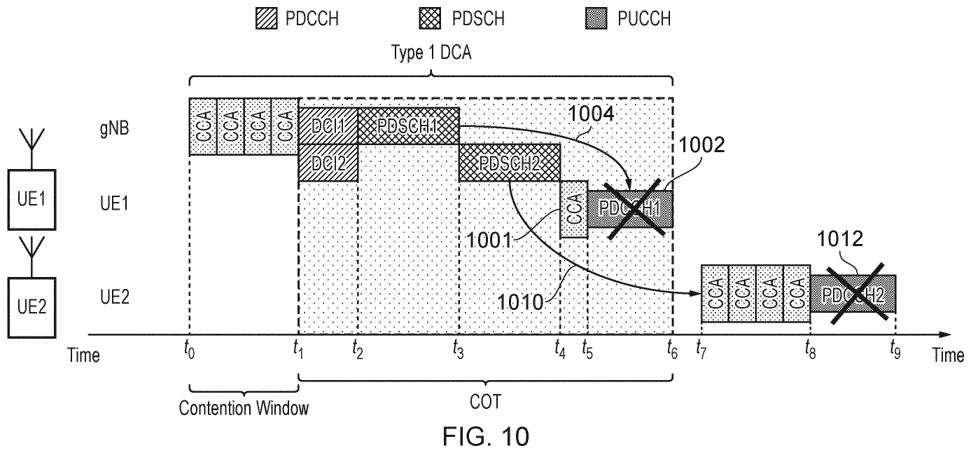

An example illustration is shown in FIG. 10. In the example shown in FIG. 10, a gNB acquires a COT after performing CCA's and transmits two downlink control information transmissions DCI1, DCI2 scheduling PDSCH1 and PDSCH2 for UE1 and UE2 respectively. The corresponding HARQ-ACKs for PDSCH1 and PDSCH2 are scheduled in PUCCH1 and PUCCH2 respectively. Before transmitting PUCCH1 the UE performs Type 2 DCA but failed at a CCA process 1001 thereby unable to acquire the channel to transmit HARQ-ACK for PDSCH1 as represented by a X 1002, so that the attempt to transmit the HARQ-ACK represented by an arrow 1004 failed. PUCCH2 is scheduled outside the COT and so UE2 has to perform Type 1 DCA and here it also failed the CCA process and thereby unable to transmit the HARQ-ACK for PDSCH2, so that the attempt to transmit the HARQ-ACK represented by an arrow 1010 failed as represented by X 1012. The gNB may have to retransmit PDSCH1 and PDSCH2 which even if they are successfully received by UE1 and UE2 respectively since the corresponding HARQ-ACK feedbacks are not transmitted.

Recognising that the resource for HARQ-ACK may not be available, a Non-Numerical K1 (NN-K1) and two new HARQ-ACK codebooks (CB) have been proposed for NR-U. The K1 indicator is a known value indicating the temporal position of the uplink resources in the PUCCH after the end of the PDSCH for which a HARQ-ACK is to be transmitted. A NN-K1 indicates to the UE that no resources have yet been provided for the HARQ-ACK to be transmitted.

As described above, a time resource of a PUCCH carrying HARQ-ACK is indicated in the “PDSCH-to-HARQ_feedback timing indicator” of the downlink grant as K1 slots or sub-slots after the end of the associated PDSCH. Since the PUCCH resource in NR-U is not guaranteed, the gNB may wish to delay providing a PUCCH resource or is not confident of providing one when the downlink grant is sent. In such a case a Non-Numerical K1 (NN-K1) is indicated in the “PDSCH-to-HARQ_feedback timing indicator” of the downlink grant thereby not reserving any PUCCH resource for HARQ-ACK feedback of the PDSCH. This is beneficial for cases when the UE has an unlikely chance of acquiring the channel for the scheduled PUCCH, such as resources outside of the COT, for example PUCCH2 in FIG. 10. Effectively, NN-K1 indication allows the gNB to delay transmission of a PDSCH HARQ-ACK feedback. For Type 2 HARQ-ACK codebook operations, HARQ-ACKs associated with NN-K1 are transmitted in a next available PUCCH, i.e. PUCCH scheduled by a downlink grant where the K1 has a numerical value.

Two new HARQ-ACK codebooks may also be used, which are an enhanced Type 2 HARQ-ACK codebook (e-Type 2 CB) and a Type 3 HARQ-ACK codebook (Type 3 CB), which are introduced to provide resources for NN-K1 HARQ-ACKs and for retransmission of HARQ-ACKs due to failed LBT (contentious access in unlicensed band).

Enhanced Type 2 HARQ-ACK codebook (e-Type 2 CB) is derived from Type 2 HARQ-ACK codebook, which is a dynamic HARQ-ACK codebook. In e-Type 2 CB, two PDSCH groups are introduced where a PDSCH can be grouped into PDSCH Group 1 or PDSCH Group 2. The PDSCH Group is indicated in a new DCI field “PDSCH group index” of DCI Format 1_1 and each PDSCH Group has a separate Downlink Assignment Index (DAI) to keep track of the number of PDSCH being allocated. The gNB can indicate in another new 1 bit DCI field “Number of requested PDSCH group(s)” whether to multiplex HARQ-ACKs for PDSCH Group indicated in DCI field “PDSCH group index” or to multiplex HARQ-ACKs for both PDSCH Groups into a scheduled PUCCH. The gNB can also indicate to the UE to discard all previous HARQ-ACKs of a PDSCH Group (including those associated with NN-K1) in a new DCI field “New feedback indicator” (NFU. The NFI field is a one bit field which is toggled, so that, if the NFI is toggled, the UE discards the HARQ-ACK feedbacks associated with a PDSCH Group indicated in a DCI field “PDSCH group index” and resets the DAI counter for that PDSCH Group.

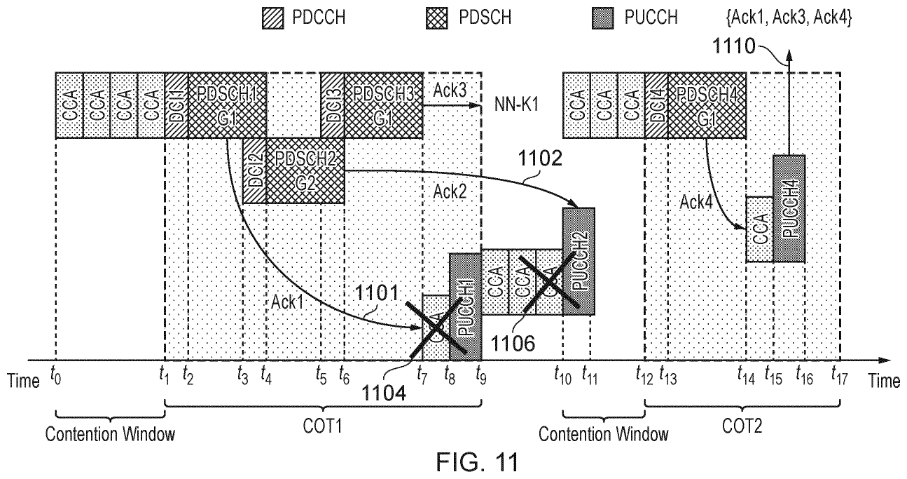

An example of transmissions from a gNB and a UE according to an e-Type 2 HARQ-ACK codebook is shown in FIG. 11. According to the example shown in FIG. 11, the gNB acquires a COT1 at time t₁ and transmits three downlink control information transmissions DCI1, DCI2, DCI3 to schedule downlink data transmissions PDSCH1, PDSCH2, PDSCH3 respectively for a UE. PDSCH1 and PDSCH3 are associated with PDSCH Group 1 whilst PDSCH2 is associated with PDSCH Group 2. Transmission of HARQ-ACKs on uplink control channels PUCCH1, PUCCH2, represented by arrows 1101, 1102, are scheduled to carry HARQ-ACK for PDSCH1 and PDSCH2 respectively. However as a result of contentious access in the unlicensed band the UE fails to acquire a channel for these PUCCH's as represented by Xs 1104, 1106. The gNB indicates NN-K1 for PDSCH3, which means that the corresponding HARQ-ACK is not allocated a PUCCH resource. At time t₁₂, the gNB acquires COT2 and transmits DCI4 to schedule PDSCH4 which is indicated as PDSCH Group 1 and the HARQ-ACK is scheduled to be carried by PUCCH4. The “Number of requested PDSCH group(s)” field in DCI4 is set to 1, because only previous HARQ-ACKs belonging to PDSCH Group 1 are multiplexed into PUCCH4. At time t₁₅, the UE successfully acquires the channel and transmits PUCCH4 which includes HARQ-ACKs for PDSCH1, PDSCH3 and PDSCH4 as represented by an arrow 1110.

Type 3 HARQ-ACK codebook introduces a new 1 bit DCI field “One-shot HARQ-ACK request” (1-shot) in DCI Format 1_1, which indicates to the UE to transmit PDSCH HARQ-ACK feedbacks for all configured HARQ processes regardless whether the HARQ-ACK has been transmitted previously, failed due to LBT or not transmitted due to NN-K1 indication.

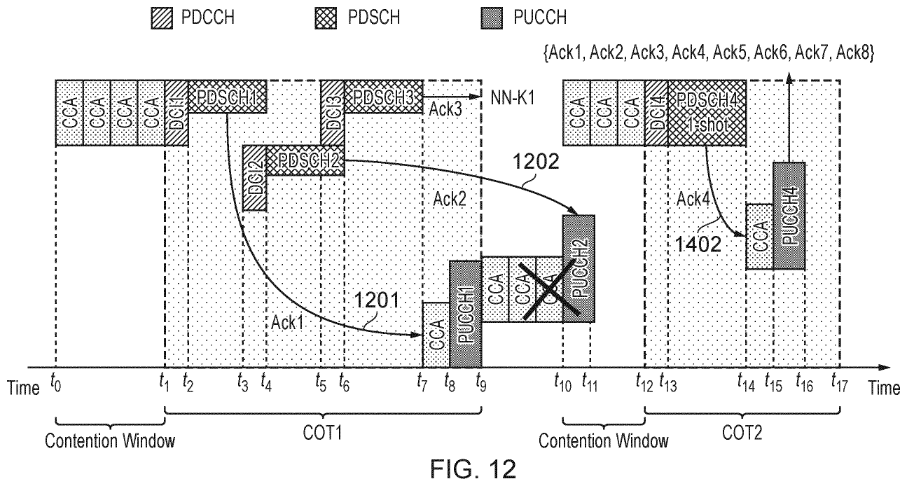

An example of the application of the 1-shot HARQ-ACK is shown in FIG. 12. According to the example shown in FIG. 12 a UE is configured with eight HARQ processes for downlink transmission via shared resources of the PDSCH. According to this example a gNB acquires a COT1 at time t1 and transmits down link control information DCI1, DCI2, DCI3 to schedule transmission of data on three corresponding downlink physical channels PDSCH1, PDSCH2, PDSCH3 respectively. The HARQ-ACK for data transmitted on PDSCH1, PDSCH2 are scheduled in resources of an uplink control channel PUCCH1, PUCCH2 respectively as represented by arrows 1201, 1202. However the DCI3 indicates NN-K1 for PDSCH3, which means that there is no specific uplink resources allocated for the transmission of the HARQ-ACK. The UE successfully transmitted PUCCH1 but failed LBT and contentious access and therefore did not transmit PUCCH2. At time t₁₂, the gNB acquires COT2 and transmits a DCI4 to schedule a PDSCH4 with corresponding HARQ-ACK scheduled in a PUCCH4 for the Ack4 as represented by an arrow 1204. The DCI4 also sets a 1-shot to true and so the UE transmits HARQ-ACK for all eight HARQ processes, Ack1, Ack2, Ack3, Ack4, Ack5, Ack6, Ack7, Ack8, including those it had successfully transmitted (Ack1) such as that for PDSCH1 and those it did not transmit such as for PDSCH2 and PDSCH3. For this example, the UE also transmits PDSCH HARQ-ACK for other HARQ processes not shown in FIG. 12.

While new Codebook types have been proposed to manage the increased risk of HARQ-ACK transmissions that could not be transmitted, in unlicensed spectrum, the current arrangements suffer from technical limitations which have undesirable effects. For example, these Codebooks do not take L1 priorities into account. Also, increasing the number of Codebooks is expected to result in increased transmissions delays as the UE has to wait for the next transmission with the same Codebook to attempt a transmission (if NN-K1 was used) or re-transmission (if LBT failed at a previous attempt) of an outstanding HARQ-ACK transmission.

Such delays and inability to handle L1 priorities are undesirable for systems which aim to provide low latency transmissions, for examples in a system where URLLC is used.

More specifically, regarding the priority aspects mentioned above, the new HARQ-ACK codebooks, e-Type 2 and Type 3 and NN-K1 are introduced in NR-U Release-16 assuming L1 priority indicator is not configured. Additionally, in Release-16, e-Type 2 and Type 3 CBs are supported only in DCI Format 1_1.

Turning to more recent developments (e.g. Release-17 systems), proposals have been made to support NN-K1, e-Type 2 CB and Type 3 CB with L1 priority in DCI Format 1_1 and DCI Format 1_2, for example in R1-2003845 [10]. It has been suggested that, if a first DCI indicates NN-K1, then a second (later) DCI that schedules a PUCCH with a valid K1 value should:
For Type 2 CB: The PUCCH scheduled by the second DCI must have the same L1 priority as that of the 1^{st} DCI. In other words, both the first and second DCI need to be associated the same Codebook and priority.
For e-Type 2 CB: For the second DCI, both the L1 priority of the corresponding PUCCH and the PDSCH Group must correspond to those of the first DCI. In other words, both the first and second DCI need to be associated the same Codebook, the same Group and the same priority.
For Type 3 CB: It has been proposed that all HARQ-ACK are transmitted regardless of L1 priority. In other words, both the first and second DCI need to be associated the same Codebook.

As will be appreciated, HARQ-ACK transmissions may be multiplexed and this is done within each Codebook.

It should be noted that NN-K1 is not used with a Type 1 CB as such a CB is associated with predetermined resources allocation which are already known in advance. In case a Type-1 CB transmission results in a HARQ-ACK transmission or feedback that could not transmitted, this is expected to be the result of a failed attempt to access the unlicensed resources, e.g. after a failed LBT.

In some systems such as Release-16 systems (for example when using eURLLC), a UE can be configured with different PUCCH L1 priorities where each L1 priority can use a different HARQ-ACK Codebook Type. For example a first Codebook may be associated with high priority transmissions while a second Codebook may be associated with low priority transmissions. In one example, Low L1 priority PUCCH transmissions may be associated with e-Type 2 CB whilst High L1 priority PUCCH transmissions may be associated with Type 2 CB. Accordingly, Low Priority transmissions may have HARQ-ACK transmissions multiplexed together if they are associated with the same Group. On the other hand, any suitably timed HARQ-ACK transmissions for High Priority transmissions may be multiplexed with each other. Accordingly, different Codebooks will be used in parallel, and operate separately depending on priority. As mentioned above, the multiplexing of HARQ-ACK transmissions occurs within the same CodeBook (associated with the corresponding L1 priority).

It is noteworthy that, due to their different nature, different HARQ-ACK Codebooks have different indicators. For example e-Type 2 CB uses PDSCH Group and includes a corresponding indicator but this indicator is not used in Type 2 CB or Type 3 CB. Additionally, the DCI fields themselves are flexible. For example, DCI Format 1_2 may configure the L1 priority indicator and another DCI Format 1_1 may not be configured to have a L1 priority indicator.

### Multiplexing Missed HARQ-ACK Messages

According to an example implementation of the present disclosure, there is provided an arrangement where, when a first HARQ-ACK transmission for a first Codebook is missed, the HARQ-ACK transmission may be multiplexed with a HARQ-ACK transmission for a second Codebook, using resources for the second HARQ-ACK transmission.

In the present disclosure, a missed HARQ-ACK transmission generally refers to a case where the UE could not transmit an acknowledgement for a previously received transmission. This may for example happens when allocated resources were deemed not available (e.g. in an unlicensed spectrum where other systems compete for the wireless resources) or if allocated resources were not provided, for example when a NN-K1 indicator was associated with the previously received transmission.

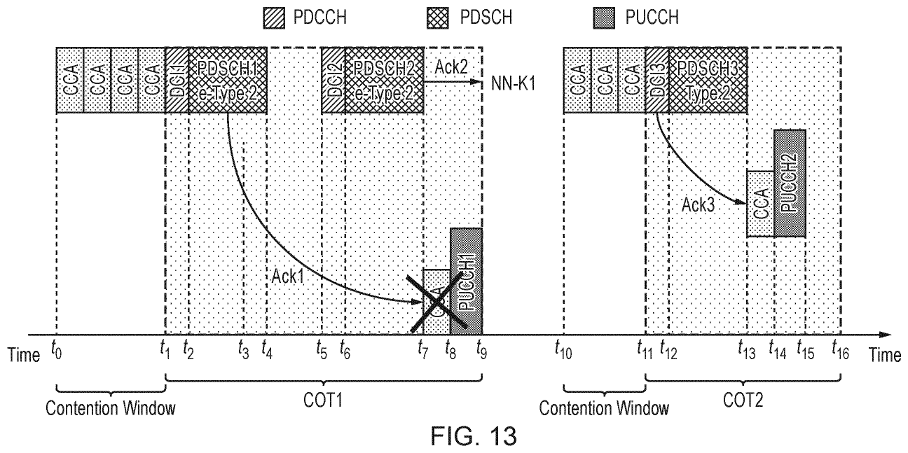

FIG. 13 schematically represents an example use of a combination of an e-Type 2 Codebook and a Type 2 Codebook in an unlicensed spectrum.

In the foregoing, we refer to a first DCI as the earlier DCI with a missed HARQ-ACK and the second DCI is the later DCI providing the resource for the missed HARQ-ACK. The first DCI is associated with a first HARQ-ACK CB where the HARQ-ACK may be carried by a first PUCCH or first PUSCH or may be delayed using NN-K1. The second DCI is associated with a second HARQ-ACK CB where the HARQ-ACK is carried by a second PUCCH or a second PUSCH. In the interest of conciseness, transmissions using PUCCH will generally be discussed but the same teachings apply equally to transmissions using PUSCH.

It should be noted that the first DCI and second DCI can be of the same DCI Format (e.g. the first DCI uses Format 1_2 & the second DCI uses Format 1_2) or can use different DCI Formats (e.g. the first DCI uses Format 1_1 & the second DCI uses Format 1_2).

In the Example of FIG. 13, two different example “first” DCI are illustrated, namely DCI1 and DCI2, wherein each of DCI1 and DCI2 illustrates a separate example of missed HARQ-ACK transmissions. A “second” DCI is also illustrated, namely DCI3.

DCI1 and DCI2 schedules PDSCH1 & PDSCH2 respectively with their corresponding HARQ-ACK feedback being associated with e-Type 2 CB. In this example, the HARQ-ACK for PDSCH1 is scheduled to be transmitted using PUCCH1 but the UE failed the LBT process and hence it is not transmitted. In this case, the UE will use a Type-2 access to attempt to transmit using PUCCH1. However, the same teachings will apply if the resources are allocated outside of COT1 and if the UE will attempt to use PUCCH1 using a Type-1 access. Returning to FIG. 13, DCI2 indicates NN-K1 and so the HARQ-ACK for PDSCH2 is also not transmitted.

In COT2, the base station transmits DCI3 scheduling PDSCH3 with corresponding HARQ-ARQ associated with Type 2 CB being transmitted in PUCCH2.

In accordance with an example of the present disclosure, the missed HARQ-ACKs for PDSCH1 and PDSCH2 are to be multiplexed into PUCCH2. As a result, PUCCH2 (associated with PDSCH3) can carry Ack1, Ack2 and Ack3.

Using In this example:
The HARQ-ACK CB associated with first DCI (DCI1 and DCI2) is the first HARQ-ACK CB which in this example is e-Type 2
The HARQ-ACK CB associated with second DCI (DCI3) is the second and different HARQ-ACK CB which in this example is Type 2
A first PUCCH is scheduled by a first DCI (in this case PUCCH1) which the UE is unable to use and/or the UE is not having resources scheduled from the HARQ-ACK for a transmission associated with a first DCI.
A second PUCCH is scheduled by a second DCI and in this case PUCCH2 is the second PUCCH

By multiplexing HARQ-ACK messages which correspond to different codebooks, the UE may possibly require more processing capabilities but it will benefit from lower latency as the UE is expected to be able to use an earlier transmission opportunity to multiplex its outstanding HARQ-ACK it was previously unable to send.

Different sets of rules may be implemented for the terminal to decide whether to multiplex the HARQ-ACK messages or not, or possibly to decide on which HARQ-ACK to multiplex and on which not to multiplex. The following sections discuss possible rules which can be used to configure the multiplexing or non-multiplexing of the HARQ-ACKs depending on the codebook for the first DCI and second DCI.

### Type 2—e-Type 2

If the first HARQ-ACK CB is Type 2 CB and the second HARQ-ACK CB is e-Type 2 CB, then the missed HARQ-ACK for the first DCI would not have a PDSCH Group whilst the second DCI providing the resource for missed HARQ-ACK can indicate a PDSCH Group.

In an example, the UE multiplexes missed HARQ-ACK that do not have an associated PDSCH Group (e.g. for the PDSCH scheduled by the first DCI) into the resource scheduled by second DCI (e.g. a PUCCH or PUSCH as provided by the second DCI). Said differently, the missed HARQ-ACK without any PDSCH Group and missed HARQ-ACK with PDSCH Group indicated by the second DCI are multiplexed into the second PUCCH or second PUSCH.

In an example, the UE does not multiplex missed HARQ-ACK that do not have an associated PDSCH Group (i.e. PDSCH scheduled by the first DCI) into the resources scheduled by the second DCI if the second DCI indicates only one requested PDSCH Group. This can for example be indicated by an indicator “Number of requested PDSCH group(s)”=1.

In an example, the UE multiplexes missed HARQ-ACK that do not have an associated PDSCH Group (e.g. PDSCH scheduled by the first DCI) into the resources scheduled by the second DCI if the second DCI indicates both requested PDSCH Groups. This can for example be indicated by an indicator “Number of requested PDSCH group(s)”=2. It should be noted that this example is based on a current configuration using two Groups but the same teachings and principles could be applied if the number of groups is greater than 2.

In an example, the UE multiplexes missed High L1 priority HARQ-ACKs that do not have an associated PDSCH Group (i.e. PDSCH scheduled by the first DCI) into the resources scheduled by the second DCI regardless of the PDSCH Group indicated in the second DCI.

In this example, Low L1 priority HARQ-ACK may for example not be multiplexed into the resources or may be multiplexed (or not) depending on a group indicator (e.g. “Number of requested PDSCH group(s)”). Generally, different sets of multiplexing rules may be applied depending on whether the first DCI is associated with corresponding different priorities.

In an example, the UE is configured via RRC signalling to operate with one or more of the above examples.

### e-Type 2—Type 2

This corresponds to the example illustrated in FIG. 13 where the first DCIs (DCI1 and DC2) are for a e-Type 2 CB and the second DCI is for a Type 2 CB.

If the first HARQ-ACK CB is e-Type 2 CB and the second HARQ-ACK CB is Type 2 CB, then the missed HARQ-ACK for the first DCI has an associated PDSCH Group whilst the second DCI providing the resource for missed HARQ-ACK does not have any PDSCH Group.

In an example, all missed HARQ-ACKs with any PDSCH Group are multiplexed into the resources (second PUCCH or second PUSCH) scheduled by the second DCI (that has no associated PDSCH Group). That is, the PUCCH scheduled by the second DCI will carry missed HARQ-ACKs that has an associated PDSCH Group and those without any associated PDSCH Group and e-Type 2 HARQ-ACK are treated as Type 2 HARQ-ACK in this example.

In an example, a pre-defined PDSCH Group is multiplexed into the resources (second PUCCH or second PUSCH) scheduled by the second DCI (that has no associated PDSCH Group). That is the PUCCH scheduled by the second DCI will carry missed HARQ-ACK from one type of PDSCH Group together with missed HARQ-ACK without associated PDSCH Group. This may for example be particularly useful one of the Groups is expected to carry transmissions associated with a lower latency target than the other (or another) Group.

In an example, the said pre-defined PDSCH Group is configured via RRC signalling and/or defined in the standard specifications.

In an example, the UE is configured via RRC signalling to operate with one or more of the above examples.

### Type 2—Type 3

In an example, if the first HARQ-ACK CB is Type 2 and the second HARQ-ACK CB is Type 3, then the resource scheduled by the second DCI carries all HARQ-ACKs (for all HARQ processes) including missed HARQ-ACKs scheduled by the first DCI if the second DCI indicates 1-shot=TRUE (i.e. “One-shot HARQ-ACK request”=TRUE). In a legacy system, all HARQ-ACKs for all HARQ processes which were associated with “CodeBook Type 3” would be transmitted, but only these. On the other hand, in this case the HARQ-ACKs will also include the “one shot” feedback for HARQ processes associated with Type 2.

In an example, if the first HARQ-ACK CB is Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs.

In an example, if the first HARQ-ACK CB is Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have the same L1 priority.

In an example, if the first HARQ-ACK CB is Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have a High L1 priority.

In an example, the UE is configured via RRC signalling to operate with one or more of the above examples.

### Type 3—Type 2

In an example, if the first HARQ-ACK CB is Type 3 and the second HARQ-ACK CB is Type 2, then the resource scheduled by the second DCI carries all missed HARQ-ACKs.

In an example, if the first HARQ-ACK CB is Type 3 and the second HARQ-ACK CB is Type 2, then the resource scheduled by the second DCI carries all missed HARQ-ACKs, where the L1 priorities of the missed HARQ-ACK scheduled by the first DCI and the second DCI are the same.

In an example, if the first HARQ-ACK CB is Type 3 and the second HARQ-ACK CB is Type 2, then the resource scheduled by the second DCI carries all missed HARQ-ACKs, where the L1 priority of the missed HARQ-ACK scheduled by the first DCI is a High priority.

In an example, if the first HARQ-ACK CB is Type 3 and the second HARQ-ACK CB is Type 2, and if the first DCI indicates “One-shot HARQ-ACK request”=TRUE, then the resource scheduled by the second DCI carries all HARQ-ACK processes. This recognises that the first HARQ-ACK CB indicated an intention to send all the HARQ-ACK processes but failed. It can be expected that in many cases, the base station will still want to receive all the HARQ-ACK responses (i.e. those that are missed and not missed, the latter ones being transmitted at least twice).

In an example, the UE is configured via RRC signalling to operate with one or more of the above examples.

### Type 1—e-Type 2

In an example, if the first HARQ-ACK CB is Type 1 and the second HARQ-ACK CB is e-Type 2, then the missed HARQ-ACK for the first DCI is multiplexed into the resources (second PUCCH or second PUSCH) scheduled by the second DCI.

In an example, if the first HARQ-ACK CB is Type 1 and the second HARQ-ACK CB is e-Type 2, then the missed HARQ-ACK for the first DCI is associated with pre-defined PDSCH Group (e.g. PDSCH Group #0). That is, the PUCCH scheduled by the second DCI will carry missed HARQ-ACK from one type of PDSCH Group together with missed HARQ-ACK without a PDSCH Group originally associated with it in cases where the Group of the second DCI corresponds to the pre-defined Group (e.g. PDSCH Group #0). Accordingly, a pre-defined or default Group may be associated with HARQ ACKs with a CodeBook Type 1—or generally with HARQ ACKs not associated with a Group, such as HARQ ACKs with Codebooks of Type 1, 2 or 3—and when an e-Type 2 HARQ ACK of the same Group is scheduled for transmission, then the HARQ ACKs that have been associated the default Group will be transmitted with it.

In an example, the said pre-defined PDSCH Group is configured via RRC signalling and/or defined in the standard specifications.

5 In an example, the UE is configured via RRC signalling to operate with one or more of the above examples.

### Type 1—Type 3

In an example, if the first HARQ-ACK CB is Type 1 and the second HARQ-ACK CB is Type 3, then the resource scheduled by the second DCI carries all HARQ-ACKs (for all HARQ processes) including missed HARQ-ACKs scheduled by the first DCI if the second DCI indicates 1-shot=TRUE (i.e. “One-shot HARQ-ACK request”=TRUE). In a legacy system, all HARQ-ACKs for all HARQ processes which were associated with “CodeBook Type 3” would be transmitted, but only these. On the other hand, in this case the HARQ-ACKs will also include the “one shot” feedback for HARQ processes associated with Type 1.

In an example, if the first HARQ-ACK CB is Type 1 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs.

In an example, if the first HARQ-ACK CB is Type 1 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have the same L1 priority.

In an example, if the first HARQ-ACK CB is Type 1 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have a High L1 priority.

In an example, the UE is configured via RRC signalling to operate with one or more of the above examples.

### e-Type 2—Type 3

In an example, if the first HARQ-ACK CB is e-Type 2 and the second HARQ-ACK CB is Type 3, then the resource scheduled by the second DCI carries all HARQ-ACKs (for all HARQ processes, including HARQ-ACK that weren't missed, thereby including missed HARQ-ACKs scheduled by the first DCI) if the second DCI indicates 1-shot=TRUE (i.e. “One-shot HARQ-ACK request”=TRUE). In a legacy system, all HARQ-ACKs for all HARQ processes which were associated with “CodeBook Type 3” would be transmitted, but only these. On the other hand, in this case the HARQ-ACKs will also include the “one shot” feedback for HARQ processes associated with e-Type 2.

In an example, if the first HARQ-ACK CB is e-Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs.

In an example, if the first HARQ-ACK CB is e-Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have the same L1 priority indicated in the first DCI and second DCI.

In an example, if the first HARQ-ACK CB is e-Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have a High L1 priority indicated in the first DCI.

In an example, if the first HARQ-ACK CB is e-Type 2 and the second HARQ-ACK CB is Type 3, and the second DCI did not indicate 1-shot (i.e. “One-shot HARQ-ACK request”=FALSE), then the resource scheduled by the second DCI carries all missed HARQ-ACKs that have a pre-determined PDSCH Group associated with the e-Type2 CB of the first DCI. The pre-determined PDSCH Group can be configured via RRC signalling and/or defined in the standard specifications.

In an example, the UE is configured via RRC signalling to operate with one or more of the above examples.

### Type 3—e-Type 2

In an example, if the first HARQ-ACK CB is Type 3 and the second HARQ-ACK CB is e-Type 2, then the resource scheduled by the second DCI carries all missed HARQ-ACKs of the PDSCH Group(s) that is indicated in the second DCI. For example, one or more of the following rules may be applied:
if the second DCI indicates “PDSCH group index”=1 and “Number of requested PDSCH group(s)”=1, then only missed HARQ-ACK of PDSCH Group 1 are multiplexed
if the second DCI indicates “PDSCH group index”=2 and “Number of requested PDSCH group(s)”=1, then only missed HARQ-ACK of PDSCH Group 2 are multiplexed
if the second DCI indicates “Number of requested PDSCH group(s)”=2, then all missed HARQ-ACK (regardless of PDSCH Group) are multiplexed

In an example, where Type 3 is the 1^{st} HARQ-ACK CB and e-Type 2 is the 2^{nd} HARQ-ACK CB, a PDSCH Group for Type 3 CB can be pre-defined, e.g. using RRC configuration. For a PDSCH that has not been assigned a PDSCH Group, for example by a downlink Grant associated to e-Type 2 HARQ-ACK CB, one or more of the following implementations can be used:
a HARQ Process or HARQ Process ID can be configured with a PDSCH Group, all PDSCH sent as part of this HARQ Process or associated with this HARQ Process ID can then be associated with the configured PDSCH Group.
Each L1 priority is assigned to a PDSCH Group, e.g. High L1 priority is assigned to PDSCH Group 1 and Low L1 priority is assigned to PDSCH Group 2
Every PDSCH—or in some cases every PDSCH not otherwise assigned a Group (e.g. based on rules such as the ones above or not assigned via e-Type 2 HARQ-ACK CB)—is assigned to a default PDSCH Group

In an example, if the first HARQ-ACK CB is Type 3 and the second HARQ-ACK CB is e-Type 2, then the resource scheduled by the second DCI carries all missed HARQ-ACKs, where the L1 priorities of the missed HARQ-ACK scheduled by the first DCI and the second DCI are the same.

In an example, if the first HARQ-ACK CB is Type 3 and the second HARQ-ACK CB is e-Type 2, then the resource scheduled by the second DCI carries all missed HARQ-ACKs, where the L1 priority of the missed HARQ-ACK scheduled by the first DCI is a High priority.

In an example, if the first HARQ-ACK CB is Type 3 and the second HARQ-ACK CB is e-Type 2, and if the first DCI indicates “One-shot HARQ-ACK request”=TRUE, then the resource scheduled by the second DCI carries all HARQ-ACK processes. This recognises that the first HARQ-ACK CB indicated an intention to send all the HARQ-ACK processes but failed. It can be expected that in many cases, the base station will still want to receive all the HARQ-ACK responses (i.e. those that are missed and not missed, the latter ones being transmitted at least twice).

In an example, the UE is configured via RRC signalling to operate with one or more of the above examples.

Accordingly, depending on the codebooks used for the first and second transmissions—and optionally on one or more of (i) priority information for one or both of the first and second transmissions; (ii) Group information for one or both of the first and second transmissions; (iii) a parameter associated with the first transmission (e.g. in the first DCI) and (iv) a parameter associated with the second transmission (e.g. in the second DCI)—the terminal can decide whether to multiplex the missed HARQ-ACK in resources for a HARQ-ACK for a further transmission or not.

While the discussion above is limited to two CodeBooks, it will be appreciated that more than two CodeBooks may be considered or made to work together in some examples. If for example the arrangement comprises rules to determine how to handle HARQ ACKs for (rule 1) a first DCI for a missed Type 1 HARQ-ACK and a second DCI for a Type 2 HARQ-ACK and (rule 2) a first DCI for a missed e-Type 2 HARQ-ACK and a second DCI for a Type 2 HARQ-ACK, then these can be made to operate in combination with each other.

For example, if a first HARQ-ACK transmission associated with a HARQ-ACK Type 1 CB is missed (e.g. unable to access the resources following LBT procedure) and a second HARQ-ACK transmission associated with a HARQ-ACK e-Type 2 CB is missed before a third HARQ-ACK transmission associated with a HARQ-ACK Type 2 can be sent, the rules above (rule 1) and (rule 2) can be applied and combined. Accordingly, in some case, the HARQ-ACK transmission may multiplex three HARQ-ACK messages of three different types.

In some of these cases, only the last two codebooks would be considered in accordance with the techniques discussed herein. In some examples, priority may also be taken into account, e.g. if the first missed HARQ-ACK is a high priority and second missed HARQ-ACK is a low priority, the arrangement can determine that the first missed HARQ-ACK should be multiplexed with the third HARQ-ACK that is to be transmitted.

Accordingly and in view of the discussions above, a “missed” acknowledgement message may be multiplexed with a second acknowledgement message based on one or more of:
A configuration to multiplex, when the second acknowledgement message is configured with a Group under its acknowledgement scheme, a first acknowledgement message not associated with a Group with the second acknowledgement message, regardless of the Group of the second acknowledgement message;
   In some cases, this rule is applied when the first acknowledgement message is associated with a high priority and not applied with the first acknowledgement message is associated with a low priority
   In some cases, this rule is applied when the first acknowledgement message is not associated with a priority and/or regardless of its priority
A configuration to multiplex, when the second acknowledgement message is configured with one of two or more Groups under its acknowledgement scheme, acknowledgement messages not associated with a Group with the second acknowledgement message, in cases where the second acknowledgement message is associated with an indication to multiplex acknowledgement messages associated with any of the one or more Groups;
   In some cases, this rule is applied when the first acknowledgement message is associated with a low priority and not applied with the first acknowledgement message is associated with a high priority
   In some cases, this rule is applied for first acknowledgement messages associated with both a high priority and a low priority
   In some cases, this rule is applied when the first acknowledgement message is not associated with a priority and/or regardless of its priority
A configuration to multiplex, when the first acknowledgement message is configured with a Group under its acknowledgement scheme and when the second acknowledgement message is not associated with a Group, the first acknowledgement message with the second acknowledgement message, regardless of the Group of the first acknowledgement message;
   In some cases, this rule is applied when the first acknowledgement message is associated with a high priority and not applied with the first acknowledgement message is associated with a low priority
   In some cases, this rule is applied when the first acknowledgement message is not associated with a priority
A configuration to multiplex, when the first acknowledgement message is configured with a Group under its acknowledgement scheme and when the second acknowledgement message is not associated with a Group, the first acknowledgement message with the second acknowledgement message, when the Group of the first acknowledgement message is a predetermined Group;
   In some cases, this rule is applied when the first acknowledgement message is associated with a high priority and not applied with the first acknowledgement message is associated with a low priority
   In some cases, this rule is applied when the first acknowledgement message is not associated with a priority and/or regardless of its priority.
A configuration to multiplex, when the second acknowledgement message is associated with an instruction to send all previous acknowledgement messages, the first acknowledgement message with the second acknowledgement message
   In some cases, the first and second acknowledgement messages are multiplexed with acknowledgement messages of the second acknowledgement scheme, regardless of the status of their previous transmission (e.g. missed or successful) with acknowledgement messages of the second acknowledgement scheme of the first acknowledgement scheme if these had been previously missed (i.e. without or excluding acknowledgement messages of the second acknowledgement scheme which had been successfully transmitted).
   In some cases, this rule is applied when the first acknowledgement message is associated with a high priority and not applied with the first acknowledgement message is associated with a low priority.
   In some cases, this rule is applied when the first acknowledgement message is associated with the same priority as the second acknowledgement message.
   In some cases, this rule is applied when the first acknowledgement message is not associated with a priority and/or regardless of its priority.
   In some cases, when the first acknowledgement message is configured with a Group under its acknowledgement scheme, the first acknowledgement message is multiplexed when the Group is a predetermined Group (which should be understood as “one of one or more predetermined Groups) or the first acknowledgement message is multiplexed regardless of the Group.
      In some cases, when the first acknowledgement message is associated with a high priority, the first acknowledgement message is multiplexed regardless of its Group and when the first acknowledgement message is associated with a low priority, the first acknowledgement message is multiplexed when its Group is a predetermined Group.
A configuration to multiplex, when the first acknowledgement message is associated with a high priority, the first acknowledgement message with the second acknowledgement message
   In some cases, if the first message is associated with a low priority, the first message is not multiplex with the second message unless it meets another rule.

As alluded to above, different mechanisms may be used for the base station to predict the behaviour of the terminal, for example, the behaviour may be based on one of, or on a combination of, configured behaviour (e.g. via signalling to the terminal) and pre-defined behaviour (e.g. as defined in a standard).

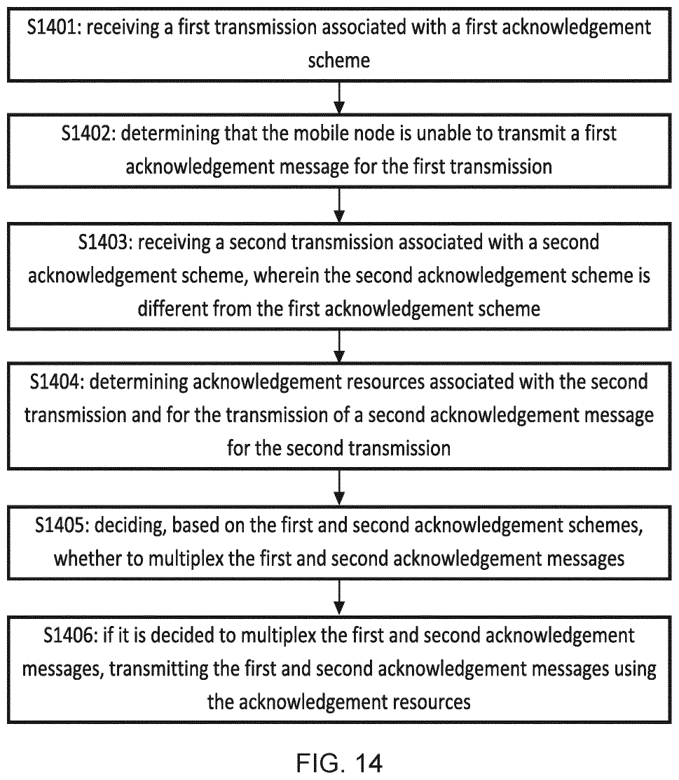

FIG. 14 schematically represents an example method for acknowledging transmissions in a telecommunications network. the method of FIG. 14 may for example be implemented in a radio node, such as a UE, terminal, relay or any other radio node operable to connect to a telecommunications network using a wireless interface. The radio node (or mobile node, mobile network node, terminal, etc.) may in some cases be a fixed node which is not expected to move location (e.g. associated with a fixed position or device) and may in other cases may a movable node whose location or position might change with time.

A first transmission associated with a first acknowledgement scheme is received at S1401 and at S1402 it is determining that the radio node is unable to transmit a first acknowledgement message for the first transmission. For example, no resources have been allocated for the first acknowledgement message (e.g. the allocation is indicated as delayed, for example using a NN-K1 indicator).

A second transmission associated with a second acknowledgement scheme is received at S1403, wherein the second acknowledgement scheme is different from the first acknowledgement scheme. The acknowledgement schemes may for example be Codebooks as discussed above.

Acknowledgement resources associated with the second transmission and for the transmission of a second acknowledgement message for the second transmission are determined at S1404. The resources may for example be for PUCCH or PUSCH resources.

At S1405 it is decided whether to multiplex the first and second acknowledgement messages, based on at least the first and second acknowledgement schemes. As mentioned above, other elements may affect the decision, for example one or more priorities, one or more Groups, one or more parameters, etc.

If it is decided to multiplex the first and second acknowledgement messages, at S1406 the first and second acknowledgement messages are transmitting using the acknowledgement resources. In other words, the multiplexing can be done by having the first and second acknowledgement messages sharing the same resources. This multiplexing or combining of these messages using the same resources may be done in any suitable way and will be familiar to the skilled person.

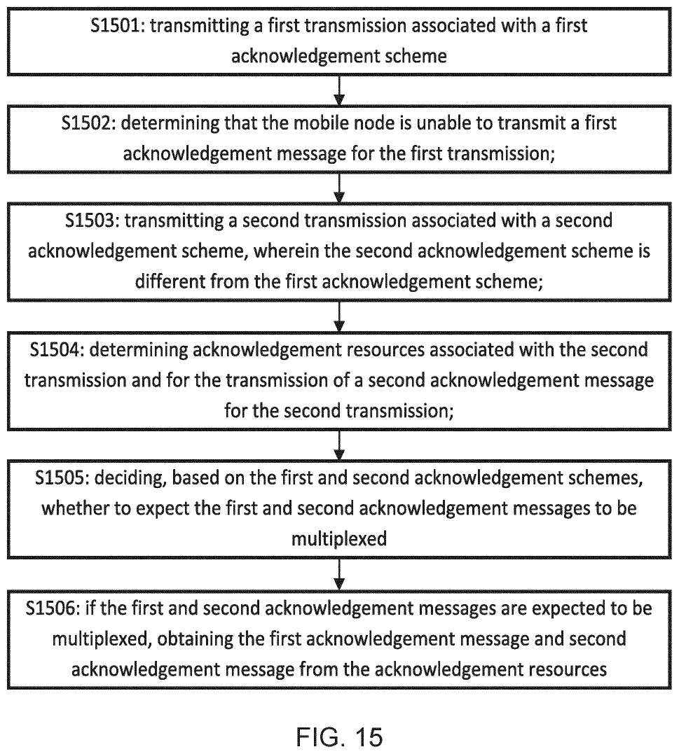

FIG. 15 schematically represents an example method for receiving transmissions acknowledgements. This method may for example be implemented by a network node. A network node may comprise a base station such as a BTS, NB, eNB or gNB, a remote radio head module, a relay, a device configured for device-to-device communication etc. From one perspective, a network node may be seen as a node operable to provide a wireless interface for a mobile terminal to connect to a telecommunication network.

A first transmission associated with a first acknowledgement scheme is transmitted at S1501. At S1502 it is determining that the radio node is unable to transmit a first acknowledgement message for the first transmission. For example, an acknowledgement was not received when expected, or the mobile was instructed to delay the transmission of the first acknowledgement message and could thus not use resources to send said message.

A second transmission associated with a second acknowledgement scheme is transmitted S1503, wherein the second acknowledgement scheme is different from the first acknowledgement scheme. The second transmission is for example transmitted to the same radio node as the first one.

Acknowledgement resources associated with the second transmission and for the transmission of a second acknowledgement message for the second transmission are determined at S1504.

At S1505, it is decided whether, based on the first and second acknowledgement schemes, to expect the first and second acknowledgement messages to be multiplexed.

In a case where they are expected to be multiplexed, the first acknowledgement message and second acknowledgement message are obtained from the acknowledgement resources (S1506).

Depending on the perspective, the control information or control signal (e.g. DCI) associated with a downlink transmissions (e.g. PDSCH) may be considered as being part of the transmission or as being a separate transmission associated with the transmission. Either way, the control information is associated with a transmission from a network node to a radio node.

In the context of the present disclosure, an unlicensed spectrum can be seen as a spectrum where devices using wireless technologies other than the one of the wireless interface (between the radio node and network node) operate in the same spectrum. Accordingly, these other devices will compete for the same resources as the radio node and network node without the network or radio nodes being able to predict the utilisation of the unlicensed spectrum by others.

The term resources or resource can refer to any suitable set of time and frequency resources to be used to transmit signals on the wireless interface. This may be measured in some cases based on a resource blocks, slots, frames or any other resource unit deemed appropriate.

Additionally, the method steps discussed herein may be carried out in any suitable order. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. For example, in the call flow of FIGS 14, S1403 and S1404 may be carried out in any suitable order, such as one after the other or at least partially in parallel. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a radio node or network node may be configured accordingly if appropriate, so long as it is technically feasible and not explicitly excluded.

Whenever the expressions “greater than” or “smaller than” or equivalent are used herein, it is intended that they discloses both alternatives “and equal to” and “and not equal to” unless one alternative is expressly excluded.

It will be appreciated that while the present disclosure has in some respects focused on implementations in a 5G or NR network as such a network is expected to provide the primary use case at present, the same teachings and principles can also be applied to other wireless telecommunications systems. Thus, even though the terminology used herein is generally the same or similar to that of the 5G (or LTE) standards, the teachings are not limited to the present versions 5G (or LTE) and could apply equally to any appropriate arrangement not based on 5G/LTE, for example any arrangement possibly compliant with any future version of an LTE, 5G or other standards—defined by the 3GPP standardisation groups or by other groups. Accordingly, the teaching provided herein using 3GPP, LTE and/or 5G/NR terminology can be equally applied to other systems with reference to the corresponding functions. For example, references to HARQ-ACK or DCI can be more generally understood as references to acknowledgements (positive or negative) or control information relating to the downlink.

It will be appreciated that the principles described herein are not applicable only to certain types of communications device, but can be applied more generally in respect of any types of communications device. For example while the techniques are expected to be particularly useful for URLLC or low latency devices, the skilled person will appreciate that they can also be applied more generally, for example in respect of any type of communications device operating with a wireless link to the communication network, or for peer-to-peer transmissions (either transmissions ending at another node of the radio access network, e.g. a communication device or any other type of node in the network, or transmissions to or from the main or core network and going through a mesh network in the radio access network).

It is noteworthy that where a “predetermined” element is mentioned, it will be appreciated that this can include for example a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product, comprising for example computer-readable instructions which can be executed by a computer, for carrying a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:

1. A method for acknowledging transmissions in a telecommunications network, the telecommunications network comprising a network node arranged to communicate with a mobile device via a wireless interface, the method comprising the radio node:

receiving a first transmission from the network node, the first transmission being associated with a first acknowledgement scheme

determining that the radio node is unable to transmit a first acknowledgement message for the first transmission,

receiving a second transmission from the network node, the second transmission being associated with a second acknowledgement scheme, wherein the second acknowledgement scheme is different from the first acknowledgement scheme;

determining acknowledgement resources associated with the second transmission and for the transmission of a second acknowledgement message for the second transmission;

deciding, based on the first and second acknowledgement schemes, whether to multiplex the first and second acknowledgement messages;

if it is decided to multiplex the first and second acknowledgement messages, transmitting the first and second acknowledgement messages using the acknowledgement resources.

Clause 2. The method of Clause 1, wherein the determination that the radio node is unable to transmit the first acknowledgement message is based on one or more of:

first resources allocated for transmitting the first acknowledgement message being unavailable for the transmitting the first acknowledgement message; and

the radio node determining that no resources were allocated, in association with the first transmission, for the transmission of the first acknowledgement message.

Clause 3. The method of Clause 2, wherein determining that no resources were allocated for the transmission of the first acknowledgement message comprises determining that a control signal comprised in the first transmission comprises an indication that the allocation of resources for the transmission of the first acknowledgement message is being delayed.

Clause 4. The method of any preceding Clause, wherein the deciding is further based on one or more of:

a first group associated with the first transmission under the first acknowledgement scheme;

a first priority associated with the first transmission;

a second group associated with the second transmission under the second acknowledgement scheme;

a second priority associated with the second transmission;

Clause 5. The method of any preceding Clause wherein the deciding is further based on one or both of: a first priority of the first transmission and a second priority of the second transmission.

Clause 6. The method of any preceding Clause wherein multiplexing the first and second acknowledgement messages comprises multiplexing the first acknowledgement message being associated with a first priority with the second acknowledgement message being associated with a second priority, wherein the first priority is different from the second priority.

Clause 7. The method of any preceding Clause wherein each of the first and second acknowledgement schemes is selected from a plurality of HARQ codebooks.

Clause 8. The method of any preceding Clause wherein spectrum for the transmissions of the first and second acknowledgement messages is an unlicensed spectrum.

Clause 9. The method of any preceding Clause wherein each of the first and second acknowledgement schemes is selected from a set of acknowledgement schemes comprising two or more of:

a first scheme under which resources allocations for the transmission of acknowledgement messages are predetermined prior to the receipt of transmissions from the network node;

a second scheme wherein resources allocations for the transmission of acknowledgement messages are defined based on received transmissions from the network node and wherein two or more acknowledgement messages can be multiplexed if the corresponding two or more transmissions are under the second codebook or, if the corresponding two or more transmissions are associated with respective priorities, if the corresponding two or more transmissions are under the second codebook and have the same associated priority;

a third scheme in which at least two transmission groups are defined, wherein resources allocations for the transmission of acknowledgement messages are defined based on received transmissions from the network node and wherein multiplexing two or more acknowledgement messages for corresponding two or more transmissions under the third codebook can be configured depending on a number of transmission groups to combine and/or on the transmission group of the respective two or more transmissions; and

a fourth scheme wherein resources allocations for the transmission of acknowledgement messages are defined based on received transmissions from the network node and wherein, when a one-shot option is activated in a specific transmission, all acknowledgement messages for a set of previous transmissions under the fourth codebook are multiplexed, the set of transmissions comprising the specific transmission.

Clause 10. The method of Clause 9 wherein one or more of:

the first scheme is a HARQ codebook Type 1;

the second scheme is a HARQ codebook Type 2;

the third scheme is a HARQ codebook e-Type 2; and

the fourth scheme is a HARQ codebook Type 3.

Clause 11. The method of Clause 10 wherein the first acknowledgement scheme and the second acknowledgement scheme are, respectively:

a HARQ codebook Type 2 and a HARQ codebook e-Type 2; or

a HARQ codebook e-Type 2 and a HARQ codebook Type 2; or

a HARQ codebook Type 2 and a HARQ codebook Type 3; or

a HARQ codebook Type 3 and a HARQ codebook Type 2; or

a HARQ codebook Type 1 and a HARQ codebook e-Type 2; or

a HARQ codebook Type 1 and a HARQ codebook Type 3; or

a HARQ codebook e-Type 2 and a HARQ codebook Type 3; or

a HARQ codebook Type 3 and a HARQ codebook e-Type 2.

Clause 12. The method of any of Clauses 9 to 11 wherein, if the second acknowledgement scheme is the third scheme, the first acknowledgement message is allocated a default transmission group wherein the default transmission group allocated to the first acknowledgement message is used to decide whether to multiplex the first acknowledgement message and the second acknowledgement message.

Clause 13. The method of any of Clauses 9 to 12 wherein, deciding whether to multiplex the first and second acknowledgement messages comprises deciding, if the third acknowledgement scheme is the fourth scheme and if the one-shot option is activated for the second transmission, to multiplex the first acknowledgement message and the second acknowledgement message.

Clause 14. A radio node for acknowledging transmissions in a telecommunications network, the telecommunications network comprising a network node arranged to communicate with the mobile device via a wireless interface, the radio node being configured to:

receive a first transmission from the network node, the first transmission being associated with a first acknowledgement scheme;

determine that the radio node is unable to transmit a first acknowledgement message for the first transmission;

receive a second transmission from the network node, the second transmission being associated with a second acknowledgement scheme, wherein the second acknowledgement scheme is different from the first acknowledgement scheme;

determine acknowledgement resources associated with the second transmission and for the transmission of a second acknowledgement message for the second transmission;

decide, based on the first and second acknowledgement schemes, whether to multiplex the first and second acknowledgement messages;

transmit, if it is decided to multiplex the first and second acknowledgement messages, the first and second acknowledgement messages using the acknowledgement resources.

Clause 15. The radio node of Clause 14 being further configured to implement the method of any of Clauses 1 to 13.

Clause 16. Circuitry for a radio node in a telecommunications network, the telecommunications network the telecommunications network comprising a network node arranged to communicate with a mobile device via a wireless interface, wherein the circuitry comprises a controller element and a transceiver element configured to operate together to:

receive a first transmission from the network node, the first transmission being associated with a first acknowledgement scheme;

determine that the radio node is unable to transmit a first acknowledgement message for the first transmission;

receive a second transmission from the network node, the second transmission being associated with a second acknowledgement scheme, wherein the second acknowledgement scheme is different from the first acknowledgement scheme;

determine acknowledgement resources associated with the second transmission and for the transmission of a second acknowledgement message for the second transmission;

decide, based on the first and second acknowledgement schemes, whether to multiplex the first and second acknowledgement messages; and

transmit, if it is decided to multiplex the first and second acknowledgement messages, the first and second acknowledgement messages using the acknowledgement resources.

Clause 17. Circuitry according to Clause 16 wherein the controller element and the transceiver element are further configured to operate together to implement the method of any of Clauses 1 to 13.

Clause 18. A method for receiving transmissions acknowledgements in a telecommunications network, the telecommunications network comprising a network node arranged to communicate with a mobile device via a wireless interface, the method comprising the network node:

transmitting a first transmission to the radio node, the first transmission being associated with a first acknowledgement scheme;

determining that the radio node is unable to transmit a first acknowledgement message for the first transmission;

transmitting a second transmission to the radio node, the second transmission being associated with a second acknowledgement scheme, wherein the second acknowledgement scheme is different from the first acknowledgement scheme;

determining acknowledgement resources associated with the second transmission and for the transmission of a second acknowledgement message for the second transmission;

deciding, based on the first and second acknowledgement schemes, whether to expect the first and second acknowledgement messages to be multiplexed; and

if the first and second acknowledgement messages are expected to be multiplexed, obtaining the first acknowledgement message and second acknowledgement message from the acknowledgement resources.

Clause 19. The method of Clause 18, wherein the determination that the radio node is unable to transmit the first acknowledgement message is based on one or more of:

being unable to receive the first acknowledgement message using first resources allocated for transmitting the first acknowledgement message; and

determining that the network node did not allocate resources, in association with the first transmission, for the transmission of the first acknowledgement message.

Clause 20. The method of Clause 19, wherein determining that the network node did not allocate resources comprises determining that the first transmission comprises a control signal indicating that the allocation of resources for the transmission of the first acknowledgement message is being delayed.

Clause 21. A network node for receiving transmissions acknowledgements in a telecommunications network, the network node being configured to communicate with a mobile device via a wireless interface, wherein the network node is further configured to:

transmit a first transmission to the radio node, the first transmission being associated with a first acknowledgement scheme;

determine that the radio node is unable to transmit a first acknowledgement message for the first transmission;

transmit a second transmission to the radio node, the second transmission being associated with a second acknowledgement scheme, wherein the second acknowledgement scheme is different from the first acknowledgement scheme;

determine acknowledgement resources associated with the second transmission and for the transmission of a second acknowledgement message for the second transmission;

decide, based on the first and second acknowledgement schemes, whether to expect the first and second acknowledgement messages to be multiplexed; and

if the first and second acknowledgement messages are expected to be multiplexed, obtain the first acknowledgement message and second acknowledgement message from the acknowledgement resources.

Clause 22. The network node of Clause 21 wherein the network node is further configured to implement the method of any of Clauses 18 to 20.

Clause 23. Circuitry for a network node in a telecommunications network, wherein the circuitry comprises a controller element and a transceiver element configured to operate together to communicate with a mobile device via a wireless interface, and wherein the controller element and the transceiver element are further configured to operate together to

transmit a first transmission to the radio node, the first transmission being associated with a first acknowledgement scheme;

determine that the radio node is unable to transmit a first acknowledgement message for the first transmission;

transmit a second transmission to the radio node, the second transmission being associated with a second acknowledgement scheme, wherein the second acknowledgement scheme is different from the first acknowledgement scheme;

determine acknowledgement resources associated with the second transmission and for the transmission of a second acknowledgement message for the second transmission;

decide, based on the first and second acknowledgement schemes, whether to expect the first and second acknowledgement messages to be multiplexed; and

if the first and second acknowledgement messages are expected to be multiplexed, obtain the first acknowledgement message and second acknowledgement message from the acknowledgement resources.

Clause 24. Circuitry according to Clause 23 wherein the controller element and the transceiver element are further configured to operate together to implement the method of any of Clauses 18 to 20.

Clause 25. A system comprising a network node and a radio node, the network node being configured to communicate with the mobile device via a wireless interface, wherein the network node is according to Clause 21 or 22 and wherein the radio node is according to Clause 14 or 15.

Clause 26. A computer program product comprising instructions which, when the program is executed by a computer, cause the computer to carry out the method of any of Clauses 1 to 13 or 18 to 20.

### REFERENCES

[1] 3GPP document RP-160671, “New SID Proposal: Study on New Radio Access Technology,” NTT DOCOMO, RAN #71, Gothenburg, Sweden, 7 to 10 Mar. 2016

[2] 3GPP document RP-172834, “Work Item on New Radio (NR) Access Technology,” NTT DOCOMO, RAN #78, Lisbon, Portugal, 18 to 21 Dec. 2017

[3] 3GPP document RP-182089, “New SID on Physical Layer Enhancements for NR Ultra-Reliable and Low Latency Communication (URLLC),” Huawei, HiSilicon, Nokia, Nokia Shanghai Bell, RAN #81, Gold Coast, Australia, 10 to 13 Sep. 2018

[4] 3GPP document RP-190654, “New WID: Physical layer enhancements for NR ultra-reliable and low latency communication (URLLC),” Huawei, HiSilicon, RAN #83, Shenzhen, China, 18 to 21 Mar. 2019

[5] TR38.913, “Study on Scenarios and Requirements for Next Generation Access Technologies (Release 14)”, v14.3.0

[6] RP-190726, “Physical layer enhancements for NR ultra-reliable and low latency communication (URLLC),” Huawei, HiSilicon, RAN #83

[7] RP-193233, “Enhanced Industrial Internet of Things (IoT) and URLLC support,” Nokia, Nokia Shanghai Bell, RAN #86

[8] RP-191575, “NR-based Access to Unlicensed Spectrum,” Qualcomm, RAN #84

[9] Holma H. and Toskala A, “LTE for UMTS OFDMA and SC-FDMA based radio access”, John Wiley and Sons, 2009

[10] R1-2003845, “Feature lead summary #2 on 101-e-NR-unlic-NRU-HARQ-03 (NNK1 value),” Huawei, RAN1 #101e

[11] TS38.212 “NR: Multiplexing and channel coding (Release 16)” v16.1.0

1. A method for acknowledging transmissions in a telecommunications network, the telecommunications network comprising a network node arranged to communicate with a mobile device via a wireless interface, the method comprising the radio node:
receiving a first transmission from the network node, the first transmission being associated with a first acknowledgement scheme;
determining that the radio node is unable to transmit a first acknowledgement message for the first transmission;
receiving a second transmission from the network node, the second transmission being associated with a second acknowledgement scheme, wherein the second acknowledgement scheme is different from the first acknowledgement scheme;
determining acknowledgement resources associated with the second transmission and for the transmission of a second acknowledgement message for the second transmission;
deciding, based on the first and second acknowledgement schemes, whether to multiplex the first and second acknowledgement messages; and
if it is decided to multiplex the first and second acknowledgement messages, transmitting the first and second acknowledgement messages using the acknowledgement resources.

2. The method of claim 0, wherein the determination that the radio node is unable to transmit the first acknowledgement message is based on one or more of:
first resources allocated for transmitting the first acknowledgement message being unavailable for the transmitting the first acknowledgement message; and
the radio node determining that no resources were allocated, in association with the first transmission, for the transmission of the first acknowledgement message.

3. The method of claim 2, wherein determining that no resources were allocated for the transmission of the first acknowledgement message comprises determining that a control signal comprised in the first transmission comprises an indication that the allocation of resources for the transmission of the first acknowledgement message is being delayed.

4. The method of claim 0, wherein the deciding is further based on one or more of:
a first group associated with the first transmission under the first acknowledgement scheme;
a first priority associated with the first transmission;
a second group associated with the second transmission under the second acknowledgement scheme;
a second priority associated with the second transmission;

5. The method of claim 0, wherein the deciding is further based on one or both of: a first priority of the first transmission and a second priority of the second transmission.

6. The method of claim 0 wherein multiplexing the first and second acknowledgement messages comprises multiplexing the first acknowledgement message being associated with a first priority with the second acknowledgement message being associated with a second priority, wherein the first priority is different from the second priority.

7. The method of claim 0 wherein each of the first and second acknowledgement schemes is selected from a plurality of HARQ codebooks.

8. The method of claim 0 wherein spectrum for the transmissions of the first and second acknowledgement messages is an unlicensed spectrum.

9. The method of claim 0 wherein each of the first and second acknowledgement schemes is selected from a set of acknowledgement schemes comprising two or more of:
a first scheme under which resources allocations for the transmission of acknowledgement messages are predetermined prior to the receipt of transmissions from the network node;
a second scheme wherein resources allocations for the transmission of acknowledgement messages are defined based on received transmissions from the network node and wherein two or more acknowledgement messages can be multiplexed if the corresponding two or more transmissions are under the second codebook or, if the corresponding two or more transmissions are associated with respective priorities, if the corresponding two or more transmissions are under the second codebook and have the same associated priority;
a third scheme in which at least two transmission groups are defined, wherein resources allocations for the transmission of acknowledgement messages are defined based on received transmissions from the network node and wherein multiplexing two or more acknowledgement messages for corresponding two or more transmissions under the third codebook can be configured depending on a number of transmission groups to combine and/or on the transmission group of the respective two or more transmissions; and
a fourth scheme wherein resources allocations for the transmission of acknowledgement messages are defined based on received transmissions from the network node and wherein, when a one-shot option is activated in a specific transmission, all acknowledgement messages for a set of previous transmissions under the fourth codebook are multiplexed, the set of transmissions comprising the specific transmission.

10. The method of claim 9 wherein one or more of:
the first scheme is a HARQ codebook Type 1;
the second scheme is a HARQ codebook Type 2;
the third scheme is a HARQ codebook e-Type 2; and
the fourth scheme is a HARQ codebook Type 3.

11. The method of claim 0 wherein the first acknowledgement scheme and the second acknowledgement scheme are, respectively:
a HARQ codebook Type 2 and a HARQ codebook e-Type 2; or
a HARQ codebook e-Type 2 and a HARQ codebook Type 2; or
a HARQ codebook Type 2 and a HARQ codebook Type 3; or
a HARQ codebook Type 3 and a HARQ codebook Type 2; or
a HARQ codebook Type 1 and a HARQ codebook e-Type 2; or
a HARQ codebook Type 1 and a HARQ codebook Type 3; or
a HARQ codebook e-Type 2 and a HARQ codebook Type 3; or
a HARQ codebook Type 3 and a HARQ codebook e-Type 2.

12. The method of claim 9 wherein, if the second acknowledgement scheme is the third scheme, the first acknowledgement message is allocated a default transmission group wherein the default transmission group allocated to the first acknowledgement message is used to decide whether to multiplex the first acknowledgement message and the second acknowledgement message.

13. The method of claim 9 wherein, deciding whether to multiplex the first and second acknowledgement messages comprises deciding, if the third acknowledgement scheme is the fourth scheme and if the one-shot option is activated for the second transmission, to multiplex the first acknowledgement message and the second acknowledgement message.

14. A radio node for acknowledging transmissions in a telecommunications network, the telecommunications network comprising a network node arranged to communicate with the mobile device via a wireless interface, the radio node being configured to:
receive a first transmission from the network node, the first transmission being associated with a first acknowledgement scheme;
determine that the radio node is unable to transmit a first acknowledgement message for the first transmission;
receive a second transmission from the network node, the second transmission being associated with a second acknowledgement scheme, wherein the second acknowledgement scheme is different from the first acknowledgement scheme;
determine acknowledgement resources associated with the second transmission and for the transmission of a second acknowledgement message for the second transmission;
decide, based on the first and second acknowledgement schemes, whether to multiplex the first and second acknowledgement messages;
transmit, if it is decided to multiplex the first and second acknowledgement messages, the first and second acknowledgement messages using the acknowledgement resources.

15. (canceled)

16. A method for receiving transmissions acknowledgements in a telecommunications network, the telecommunications network comprising a network node arranged to communicate with a mobile device via a wireless interface, the method comprising the network node:
transmitting a first transmission to the radio node, the first transmission being associated with a first acknowledgement scheme;
determining that the radio node is unable to transmit a first acknowledgement message for the first transmission;
transmitting a second transmission to the radio node, the second transmission being associated with a second acknowledgement scheme, wherein the second acknowledgement scheme is different from the first acknowledgement scheme;
determining acknowledgement resources associated with the second transmission and for the transmission of a second acknowledgement message for the second transmission;
deciding, based on the first and second acknowledgement schemes, whether to expect the first and second acknowledgement messages to be multiplexed; and
if the first and second acknowledgement messages are expected to be multiplexed, obtaining the first acknowledgement message and second acknowledgement message from the acknowledgement resources.

17. The method of claim 0, wherein the determination that the radio node is unable to transmit the first acknowledgement message is based on one or more of:
being unable to receive the first acknowledgement message using first resources allocated for transmitting the first acknowledgement message; and
determining that the network node did not allocate resources, in association with the first transmission, for the transmission of the first acknowledgement message.

18. The method of claim 0, wherein determining that the network node did not allocate resources comprises determining that the first transmission comprises a control signal indicating that the allocation of resources for the transmission of the first acknowledgement message is being delayed.

19.-22. (canceled)
